(19) United States
(12) Patent Application Publication
(10) Pub. No.: US 2026/0105615 A1
(43) Pub. Date: Apr. 16, 2026

(54) IMAGE-BASED OBJECT DETECTION TECHNIQUES FOR HIGH-SPEED COUNTING ENVIRONMENTS

(71) Applicant: Optum, Inc., Minnetonka, MN (US)

(72) Inventors: Mahavir Gautham RATHINAM, Chandler, AZ (US); Toan Q. TRINH, Phoenix, AZ (US); Michael L. MAHAR, Tempe, AZ (US); Khoa T. CHAU, Litchfield Park, AZ (US)

(21) Appl. No.: 18/915,410

(22) Filed: Oct. 15, 2024

(51) Int. Cl. G06T 7/246; G06T 5/70; G06T 7/13; G06T 7/60; G06T 7/73

(52) U.S. Cl. CPC G06T 7/246; G06T 5/70; G06T 7/13; G06T 7/60; G06T 7/73; G06T 2207/20164; G06T 2207/30242

(57) ABSTRACT

Various embodiments of the present disclosure provide object identification, tracking, and counting techniques for high-speed environments. The techniques include generating denoised image frame based on a contrast threshold corresponding to a shared object attribute for a tracked target object. The techniques include generating, using an object detection model, an object matrix indicative of target object candidates based on the denoised image frame. The techniques include generating object-specific attributes for the target object candidates based on the object matrix. The techniques include identifying the tracked target object from the target object candidates based on the object-specific attributes and, in response to identifying the tracked target object, tracking and recording a tracked target object corresponding to the target object based on the object attributes recorded previously and, if necessary, modifying an object-specific count for the recorded target object.

### BACKGROUND

Various embodiments of the present disclosure address technical challenges related to object tracking in high-speed environments given limitations of existing tracking techniques. Traditional object tracking techniques for high-speed environments leverage combinations of sensors, such as photoelectric sensors, to predict a number of objects passing through a counting environment, such as a counting chamber. Due to inadequate image processing techniques, traditional counting devices rely on photoelectric sensors to detect the presence of an object. This ultimately reduces the accuracy of counting devices and limits the validation of such devices due to sensor limitations.

Some tracking techniques may leverage image capture devices to track objects in non-high-speed environments. However, these techniques are not designed to count objects in a high-speed environment and fail to distinguish between multiple related objects within a sequence of image frames. Some traditional techniques may improve detection accuracy by generating denoised images. However, traditional denoised images are object agnostic and do not consider attributes of a targeted object. This prevents traditional denoising techniques from highlighting objects of interest within a counting environment, which limits the accuracy of object detection and counting.

Various embodiments of the present disclosure make important contributions to various existing object tracking approaches by addressing these technical challenges.

### BRIEF SUMMARY

Various embodiments of the present disclosure disclose image-based object detection and tracking techniques for improved object counting in high-speed environments. As discussed herein, traditional object detection and tracking techniques that leverage image capture devices face technical challenges for detecting, tracking, and counting objects in high-speed environments. Some techniques of the present disclosure address these technical challenges by providing improved image processing techniques that generate object-specific denoised image frames that are tailored to the attributes of a target object. Some embodiments of the present disclosure leverage the object-specific denoised image frames to detect and track one or more objects over a sequence of images. By leveraging an object-specific denoised image frame, some of the techniques of the present disclosure may improve object detection by differentiating between a plurality of objects with the same image frame. By doing so, some of the techniques of the present disclosure may improve the recognition of object attributes for tracking objects across image frames. As described herein, some of the techniques of the present disclosure may be practically applied to high-speed counting environments to improve detection accuracy and validation, while monitoring the performance of a counting system.

In some embodiments, a computer-implemented method includes generating, by one or more processors, an object-specific denoised image frame for an image frame based on a contrast threshold corresponding to one or more shared object attributes for a target object; generating, by the one or more processors and using an object detection model, an object matrix indicative of one or more target object candidates based on the object-specific denoised image frame; generating, by the one or more processors, a plurality of object-specific attributes for the one or more target object candidates based on the object matrix; identifying, by the one or more processors, the target object from the one or more target object candidates based on the plurality of object-specific attributes; and in response to identifying the target object, identifying, by the one or more processors, a recorded target object corresponding to the target object based on the plurality of object-specific attributes; and modifying, by the one or more processors, an object-specific count for the recorded target object.

In some embodiments, a computing system includes memory and one or more processors communicatively coupled to the memory, the one or more processors are configured to generate an object-specific denoised image frame for an image frame based on a contrast threshold corresponding to one or more shared object attributes for a target object; generate, using an object detection model, an object matrix indicative of one or more target object candidates based on the object-specific denoised image frame; generate a plurality of object-specific attributes for the one or more target object candidates based on the object matrix; identify the target object from the one or more target object candidates based on the plurality of object-specific attributes; and in response to identifying the target object, identify a recorded target object corresponding to the target object based on the plurality of object-specific attributes; and modify an object-specific count for the recorded target object.

In some embodiments, one or more non-transitory computer-readable storage media includes instructions that, when executed by one or more processors, cause the one or more processors to generate an object-specific denoised image frame for an image frame based on a contrast threshold corresponding to one or more shared object attributes for a target object; generate, using an object detection model, an object matrix indicative of one or more target object candidates based on the object-specific denoised image frame; generate a plurality of object-specific attributes for the one or more target object candidates based on the object matrix; identify the target object from the one or more target object candidates based on the plurality of object-specific attributes; and in response to identifying the target object, identify a recorded target object corresponding to the target object based on the plurality of object-specific attributes; and modify an object-specific count for the recorded target object.

### BRIEF DESCRIPTION OF THE DRAWINGS

FIG. 1 illustrates an example computing system in accordance with one or more embodiments of the present disclosure.

FIG. 2 is a schematic diagram showing a system computing architecture in accordance with some embodiments discussed herein.

FIG. 3 is a dataflow diagram showing an example object detection and counting technique in accordance with some embodiments discussed herein.

FIGS. 4A and 4B depict operational examples of an image-based counting device in accordance with some embodiments discussed herein.

FIG. 5 depicts a singulation mechanism for an example image-based counting device in accordance with some embodiments discussed herein.

FIGS. 6A to 6C depict various views of an example counting environment in accordance with some embodiments discussed herein.

FIGS. 7A and 7B depict various views of an example indexer unit in accordance with some embodiments discussed herein.

FIG. 8 depicts a block diagram of a control system for an image-based counting device in accordance with some embodiments discussed herein.

FIG. 9 depicts an example user interfaces for the image-based counting device in accordance with some embodiments discussed herein.

FIG. 10 depicts various views of a dual-camera count chamber in accordance with some embodiments discussed herein.

FIG. 11 depicts various views of a dual-camera count chamber in accordance with some embodiments discussed herein.

FIG. 12 is a flowchart showing an example of a process for detecting and tracking an object in a high-speed environment in accordance with some embodiments discussed herein.

FIGS. 13A-D depict example image frames in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that the present disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

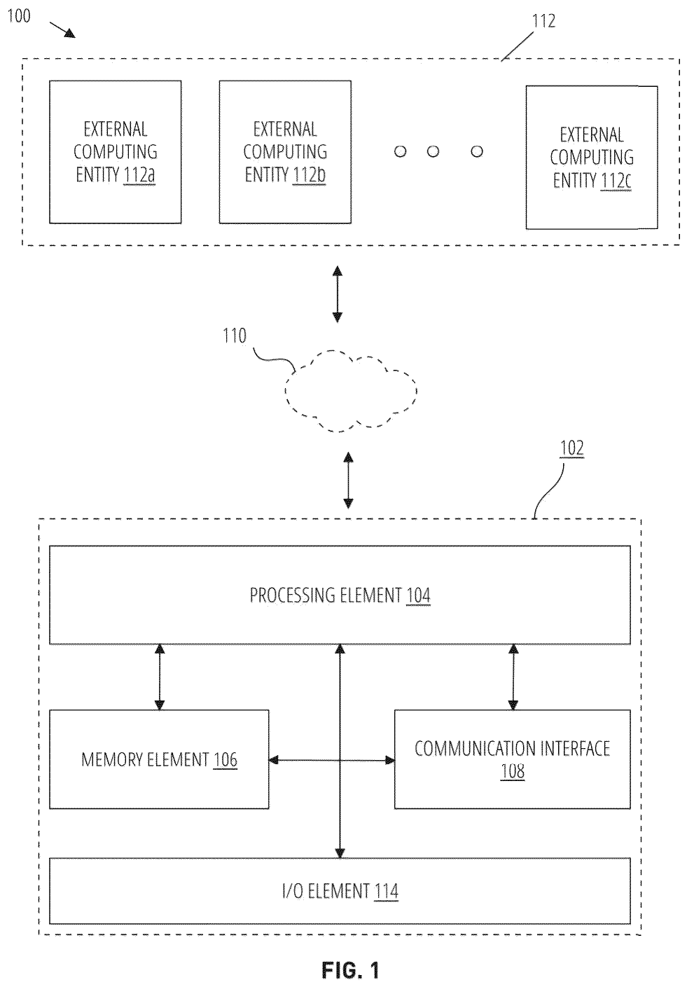

FIG. 1 illustrates an example computing system 100 in accordance with one or more embodiments of the present disclosure. The computing system 100 may include an image processing computing entity 102 and/or one or more external computing entities 112a-c communicatively coupled to the image processing computing entity 102 using one or more wired and/or wireless communication techniques. The image processing computing entity 102 may be specially configured to perform one or more steps/operations of one or more techniques described herein. In some embodiments, the image processing computing entity 102 may include and/or be in association with one or more image-based counting device(s), mobile device(s), desktop computer(s), laptop(s), server(s), cloud computing platform(s), and/or the like. In some example embodiments, the image processing computing entity 102 may be configured to receive and/or transmit data (e.g., total object counts, shared object characteristics, etc.), and/or the like from and/or to the external computing entities 112a-c to perform one or more steps/operations of one or more techniques (e.g., object tracking, counting, and/or the like) described herein.

The external computing entities 112a-c, for example, may include and/or be associated with one or more entities configured to receive, store, manage, and/or facilitate data associated with one or more target objects, and/or the like. The external computing entities 112a-c, for example, may provide one or more object attributes, contrast thresholds, target detection criteria, and/or the like for identifying, tracking, and/or counting a target object as described herein. By way of example, the image processing computing entity 102 may include an image-based counting device that is configured to leverage data from the external computing entities 112a-c and/or one or more other data sources to implement an object-specific counting technique within a high-speed environment. In addition, or alternatively, the image processing computing entity 102 may include an image-based counting device that is configured to implement an object-specific counting technique within a high-speed environment and provide insights (e.g., a total object count, etc.) from the object-specific counting technique to the external computing entities 112a-c.

The image processing computing entity 102 may include, or be in communication with, one or more processing elements 104 (also referred to as one or more processors, processing circuitry, digital circuitry, and/or similar terms used herein interchangeably) that communicate with other elements within the image processing computing entity 102 via a bus, for example. As will be understood, the image processing computing entity 102 may be embodied in a number of different ways. The image processing computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the image processing computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the image processing computing entity 102 with the assistance of the processing element 104.

As indicated, in one embodiment, the image processing computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

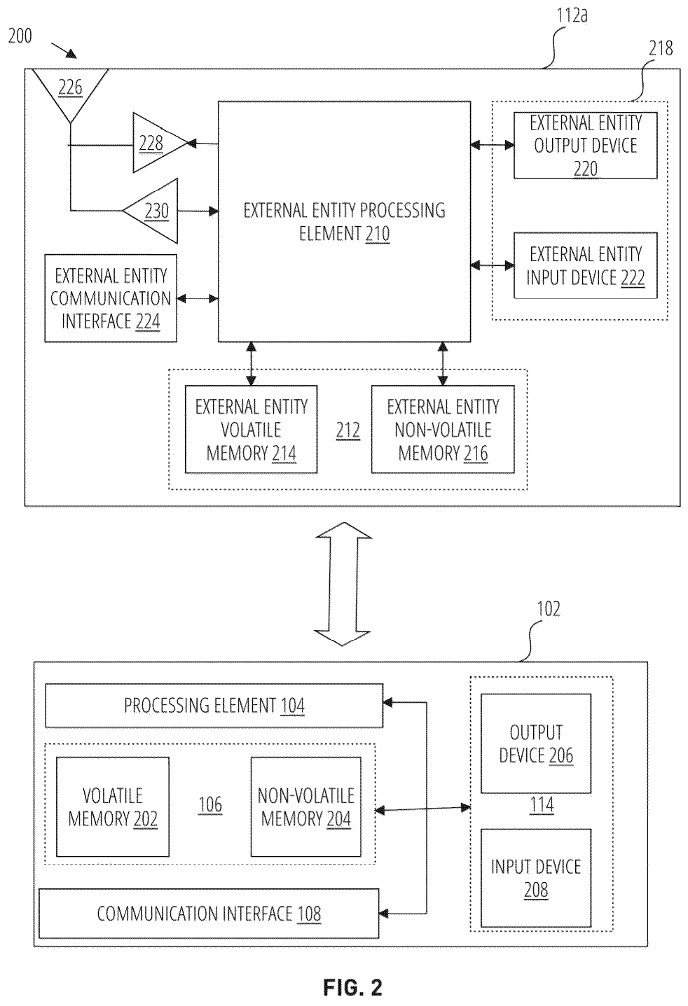

FIG. 2 is a schematic diagram showing a system computing architecture 200 in accordance with some embodiments discussed herein. In some embodiments, the system computing architecture 200 may include the image processing computing entity 102 and/or the external computing entity 112a of the computing system 100. The image processing computing entity 102 and/or the external computing entity 112a may include a computing apparatus, a computing device, and/or any form of computing entity configured to execute instructions stored on a computer-readable storage medium to perform certain steps or operations.

The image processing computing entity 102 may include a processing element 104, a memory element 106, a communication interface 108, and/or one or more I/O elements 114 that communicate within the image processing computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the image processing computing entity 102 to perform one or more step/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The image processing computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The image processing computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the image processing computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the image processing computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include one or more external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the image processing computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “image frame” refers to a data entity that describes a recorded image frame from a video sequence. An image frame may correspond to a digital image from a sequence of digital images captured by an image capture device (e.g., of the image-based counting device, etc.) over a counting time period. An image frame may include a plurality of image pixels. Each of the image pixels may be indicative of one or more visual characteristics at a particular point within an environment representation recorded by an image capture device. The one or more visual characteristics may depend on the image capture device. For example, the visual characteristics may include a size, color, position, and/or intensity of a particular point within the environment representation. The color may include a black and/or white color for a black and white image frame captured by a black and white cameras, a monochromatic color for an image frame captured by a grayscale camera, an RGB color for an image frame captured by an RGB cameras, and/or the like.

In some embodiments, an image frame is defined by a relative frame coordinate system, such that each pixel of the plurality of pixels is associated with a respective image position (e.g., relative coordinates, etc.) within the image frame. The relative frame coordinate system, for example, may include a two dimensional image frame defined by an x, y coordinate system. An image position for a respective image pixel may include a horizontal position (e.g., an x-coordinate, etc.) and/or a vertical position (e.g., a y-coordinate, etc.).

In some examples, an image frame may be indicative of one or more object candidates within a counting environment, such as a counting chamber of the image-based counting device.

In some embodiment, the term “target object candidate” refers to a data entity that is indicative of a potential object within an image frame. A target object candidate may be indicative of a pixel cluster within an image frame. In some examples, a pixel cluster may include one or more pixels of interest from an image frame that satisfy one or more initial object detection criteria. The initial object detection criteria, for example, may include computer vision detection criteria leveraged by an object detection model configured to extract one or more pixel clusters from an image frame. Each target object candidate may correspond to noise within an image frame and/or a target object within the image frame.

In some embodiments, the term “object matrix” refers to a data entity that is indicative of a plurality of target object candidates. An object matrix may include an n-dimensional matrix including a plurality of rows and columns. Each row and/or column may be indicative of a sequence of points of interest for a target object candidate. For instance, each row and/or column may be indicative of a pixel cluster from the image frame. In some embodiments, an object matrix is generated for an image frame using an object detection model.

In some embodiments, the term “object detection model” refers to a data entity that is indicative of parameters, hyper-parameters, and/or defined operations of a rules-based, statistical, and/or machine learning model (e.g., model including at least one of one or more rule-based layers, one or more layers that depend on trained parameters, coefficients, and/or the like). For instance, an object detection model may include a rule-based and/or machine learning model configured to process an image frame to generate an object matrix indicative of a plurality of target object candidates within the image frame.

In some embodiments, the object detection model is a corner detection model configured to identify a plurality of pixels of interest from an image frame. A corner detection model, for example, may include one or more different types of corner detection models, each configured to identify a pixel of interest based on one or more different initial object detection criteria. A corner detection model, for example, may include an intensity-based model, such as a Harris corner detector, and/or the like, configured to identify a pixel of interest based on a local intensity variation (e.g., a contrast between a pixel's intensity and one or more neighboring pixels' intensities) of an image. In addition, or alternatively, a corner detection model may include a contour-based model, such as a Canny edge detector, and/or the like, configured to identify a pixel of interest based on a shape of an edge contour. As another example, a corner detection model may include a model-based model configured to identify a pixel of interest by fitting the image frame into a predefined model.

In some embodiments, the object detection model is a machine learning model. For instance, the object detection model may include a machine learning model that is trained to generate an object matrix from an object-specific denoised image frame. In some examples, the object detection model may include a machine learning model including one or more supervised, unsupervised, semi-supervised, reinforcement learning models, and/or the like. In some examples, the object detection model may include multiple models configured to perform one or more different stages of a corner detection process.

In some embodiments, the object detection model includes a supervised machine learning model that is trained to generate the object matrix for the image frame. By way of example, the object detection model may be trained using one or more supervised machine learning techniques, such as back propagation of errors (e.g., a weighted-fusion layer error propagation, side-output layer error propagation, etc.), and/or the like. The object detection model may include a deep learning model, such as a deep neural network, and/or the like. For instance, the object detection model may include a trimmed convolutional neural network (e.g., very deep convolutional network, etc.) with one or more layers each configured to process the image frame to generate an object matrix.

In some embodiments, the object detection model detects one or more of the points of interest of the object matrix based on an intensity of one or more pixels of the image frame. To improve the accuracy and granularity of the points of interest extracted from the image frame the image frame may be preprocessed to increase a contrast between pixel intensities of the image frame. For example, the image frame may be preprocessed to generate the object-specific denoised image frame including a plurality of black and white pixels. As described herein, the object-specific denoised image frame may be tailored to one or more shared attributes of the target object to increase a contrast between a background and one or more target object candidates within the image frame. In this manner, the object detection model may detect a plurality of points of interest at a granular level to improve the differentiation between target object candidates within close proximities to each other.

In some embodiments, the term “tracked target object” refers to a data entity that is indicative of an object of interest for an image-based counting device. For example, a tracked target object (or “target object”) may be an object for which an image-based counting device is specially configured. A tracked target object may include any type of object and, in some examples, may be based on a prediction domain. By way of example, in a clinical prediction domain, a tracked target object may include a particular pill for which a pill counting machine may be specially configured.

In some embodiments, the term “object attribute” refers to a data parameter for a target object. An object attribute, for example, may be indicative of a characteristic of a target object. An object attribute may include an object-specific attribute corresponding to a particular target object identified within an image frame. In addition, or alternatively, an object attribute may include a shared object attribute indicative of a common characteristic shared by a plurality of target objects. A shared object attribute, for example, may be generic across each target object of a particular object type, whereas an object-specific attribute may be unique to a particular target object.

In some embodiments, an object-specific attribute is indicative of one or more of a size, shape, position, and/or the like for a target object identified within an image frame. For example, a target object may be defined by a plurality of points of interest (e.g., corner points, etc.) within an image frame. An object-specific attribute may include one or more characteristics (e.g., coordinates, intensity, etc.) for each of the plurality of points of interest. In addition, or alternatively, an object-specific attribute may include one or more characteristics derived from the plurality of points of interest. By way of example, an object-specific attribute may be indicative of a target object size. A target object size may be indicative of an area at least partially enclosed by the plurality of points of interest. The area, for example, may be indicative of a number of pixels at least partially enclosed by the plurality of points of interest. In some examples, the area may be based on a distance between an image capture device and a counting environment.

In some examples, an object-specific attribute may be indicative of a center point relative to the plurality of points of interest. In some examples, a center point may be indicative of a position of a target object. For instance, a center point may be indicative of a vertical position (e.g., a y-coordinate) and/or a horizontal position (e.g., an x-coordinate) of a target object. In some examples, an object-specific attribute may be indicative of one or more contextual characteristics, such as a color, reflectiveness, and/or the like, of a target object (e.g., one or more pixels within an area defined by the plurality of points of interest).

In some embodiments, a shared object attribute is indicative of one or more of an average size, an average shape, a dustiness level, and/or one or more other visual characteristics of a particular object type. In some examples, a shared object attribute may be indicative of one or more object characteristics that may impact a visibility of an object within a counting environment. For example, a shared object attribute may include an object consistency, object opacity, object color, and/or the like. By way of example, a shared object attribute may be indicative of an object color, lighting characteristics, such as luminosity, reflectiveness, etc., surface characteristics, such as smoothness, coating, etc., material (e.g., soft gel, hard gel, etc.), manufacturing inconsistency, and/or the like.

In some embodiments, a shared object attribute is predictive of an optimal contrast for highlighting a target object relative to a counting environment. For example, one or more shared object attributes may be leveraged to generate an object-specific denoised image frame for identifying a target object.

In some embodiments, the term “object-specific denoised image frame” refers to a modified image frame that is derived from an image frame. An object-specific denoised image frame may include a plurality of image pixels. Each of the image pixels may correspond to an image pixel from a corresponding image frame. Each of the image pixels, for example, may be an intensified counterpart to a corresponding pixel from the corresponding image frame. For instance, each of the pixels of the object-specific denoised image frame may be a white pixel (e.g., with an intensity of 255) and/or a black pixel (e.g., with an intensity of 0). By way of example, each pixel from an image frame may be converted to a white pixel and/or black pixel based on a contrast threshold to generate an object-specific denoised image frame.

In some embodiments, the term “contrast threshold” refers to a reconfigurable parameter for generating an object-specific denoised image frame. A contrast threshold may be indicative of a threshold pixel intensity for differentiating between a black and white pixel for an object-specific denoised image frame. For example, a black pixel may be generated for each pixel of an image frame with an intensity below (and/or equal to) a contrast threshold, whereas a white pixel may be generated for each pixel of the image frame with an intensity above (and/or equal to) the contrast threshold.

In some embodiments, a contrast threshold is tailored to a particular object type. For instance, a contrast threshold may be configured based on one or more shared object attributes for a target object. By way of example, a contrast threshold may be increased for a target object with one or more high intensity characteristics, such a brightness (e.g., bright color, reflective coating, etc.), opaqueness (e.g., hard gels, etc.), and/or the like. In addition, or alternatively, a contrast threshold may be decreased for a target object with one or more low intensity characteristics, such a darkness (e.g., dark color, non-reflective coating, etc.), transparency (e.g., soft gels, etc.), and/or the like. In this manner, a contrast threshold may be dynamically tailored to a particular target object to generate an object-specific denoised image frame for specifically highlighting the particular target object, while removing noise from an image frame. By doing so, some of the techniques of the present disclosure may improve accuracy of counting machines in high-speed environments by highlighting objects based on their shared characteristics.

In some embodiments, the term “target detection criteria” refers to a data entity that describes criteria for detecting an object within one or more image frames. Target detection criteria may be indicative of one or more object attributes and/or one or more thresholds for identifying a target object within an image frame. In some examples, target detection criteria may include object-specific detection criteria and/or object-agnostic detection criteria.

In some embodiments, object-agnostic detection criteria is indicative of one or more object attributes for detecting an object of any object type. For example, object-agnostic detection criteria may include a target object corner threshold. A target object corner threshold, for example, may be indicative of a threshold number of points of interest for a target object candidate. The threshold number may include any number of points of interest including three, four, ten, twenty, and/or the like. In some examples, the threshold number may be seven points of interest.

In addition, or alternatively, object-agnostic detection criteria may be indicative of one or more image frame characteristics. The image frame characteristics, for example, may be indicative of an image quality (e.g., contrast, dynamic range, spatial resolution, noise, artifacts, etc.) corresponding to an image frame. In some examples, the object-agnostic detection criteria may include one or more image quality thresholds for considering an image frame.

In some embodiments, object-specific detection criteria is indicative of one or more object attributes for detecting a target object of a particular object type. Object-specific detection criteria may include any combination of the one or more object-specific attributes for a target object. In some examples, the object-specific detection criteria may include a threshold value for one or more of the object-specific attributes. By way of example, the object-specific detection criteria may be indicative of a target object size threshold. A target object size threshold, for example, may be indicative of a threshold size (e.g., area, circumference, etc.) for a target object candidate.

In some embodiments, object-specific detection criteria is tailored to a particular type of target object. For instance, object-specific detection criteria may be based on the shared object attributes. In some examples, the object-specific detection criteria (and/or one or more of the shared object attributes) may be dynamically determined using a plurality of calibration target objects.

In some embodiments, the term “calibration target object” refers to a target object that is leveraged to determine one or more object detection criteria for calibrating an image-based counting device. A calibration target object may be input to an image-based counting device to generate one or more calibration attributes for the target object. A plurality of calibration attributes may be aggregated from a plurality of calibration target objects to determine one or more object detection criteria. For instance, a target object size threshold may include an average size (e.g., number of pixels, etc.) from the plurality of calibration attributes. In addition, or alternatively, the target object size threshold may include a minimum size from the plurality of calibration attributes, an adjusted minimum size from the plurality of calibration attributes, and/or the like. By way of example, a target object size threshold may include a percentage (e.g., sixty percent, etc.) of a minimum size recorded for a plurality of calibration target objects.

In some embodiments, the term “recorded target object” refers to a data entity that is indicative of a target object. A recorded target object may include a temporary data structure that is indicative of one or more object-specific attributes for a target object. For example, a recorded target object may include a plurality of recorded object attributes for a target object. In some examples, a recorded target object may be stored within a temporary object lookup structure for a predetermined time interval, a frame length, and/or the like.

In some embodiments, the term “temporary object lookup structure” refers to a data structure in which one or more recorded target objects are temporarily stored. A temporary object lookup structure, for example, may include a temporary database, lookup table, and/or the like that is stored in a short-term memory device (e.g., a cache memory, random access memory device, etc.). A temporary object lookup structure may be configured to store a plurality of recorded target objects for a temporary time period. In some examples, a temporary object lookup structure may be configured to store a recorded target object for a frame holdover rate.

In some embodiments, the term “recorded object attribute” refers to a parameter for a recorded target object. A recorded object attribute may be indicative of an object-specific attribute for an identified target object. In addition, or alternatively, a recorded object attribute may be indicative of a storage attribute for the recorded target object. A storage attribute may be indicative of a detection timestamp (e.g., a time at which a target object is detected), a detection duration (e.g., a time duration after a target object is detected), a detection image frame (e.g., an image frame at which a target object is first detected), an image frame length, and/or the like.

In some embodiments, the term “image frame length” refers to a storage attribute that is indicative of a storage duration for a recorded target object. An image frame length may be indicative of a number of image frames. For instance, an image frame length may be indicative of an image frame count from a detection image frame for a recorded data object. For example, an image frame length may be indicative of a number of image frames subsequent to and/or including the detection image frame.

In some embodiments, the term “frame holdover threshold” refers to a threshold that is indicative of a storage duration constraint for a recorded data object. For example, a frame holdover threshold may be indicative of a threshold image frame length for which a recorded data object may be stored within a temporary object lookup structure. By way of example, a frame holdover threshold may be indicative of a maximum number of frames (e.g., two, five, ten, twenty, etc.) for which a recorded data object may be stored. In some examples, the frame holdover rate may be indicative of five image frames. In some examples, a recorded data object may be removed from a temporary object lookup structure in the event that an image frame length exceeds a frame holdover threshold.

In some embodiments, the term “object-specific count” refers to a recorded object attribute that is indicative of a number of object detections for a target object corresponding to a recorded data object. An object-specific count, for example, may be indicative of a number of image frames in which a target object is identified. In some examples, an object-specific count may be indicative of one or more particular image frames (e.g., an image frame number, etc.) in which a target object is identified.

In some embodiments, the term “total object count” refers to a data entity that is indicative of a number of target objects identified during a time period. In some examples, a total object count may be indicative of a total number of target objects dispensed by an image-based counting device over a time period.

### IV. Overview

Embodiments of the present disclosure present image processing techniques that improve computer detection, tracking, and counting of objects across image frames. To do so, the present disclosure provides image denoising techniques for generating an object-specific denoised image frame that is tailored to a target object. The object-specific denoised image frame may be configured for a specific object to highlight the object in the image frame based on the characteristics of the object. In this manner, targeted objects within an image frame may be better distinguished from nontargeted objects and other noise within an image frame that may conventionally interfere with object detection and tracking. The image denoising techniques may be leveraged with object tracking techniques of the present disclosure to reliably detect, track, and count targeted objects in high-speed environments, such as pill counting environments in which an object is counted as the object falls through a counting chamber. The object tracking techniques, for example, may extract object characteristics from an image frame to track a targeted object across a sequence of image frames. An object may only be counted if it is tracked across multiple image frames. In this way, the present disclosure provides an improved image-based counting technique that improves upon the accuracy and reliability of conventional object counting techniques. Moreover, by using images as opposed to other sensors, some of the object tracking techniques of the present disclosure enable a level of traceability through recorded images that is not provided by conventional counting techniques.

Example inventive and technologically advantageous embodiments of the present disclosure include: (i) image processing techniques for generating an object-specific denoised image tailored to a target object; (ii) techniques for reliability counting objects in a high speed environment; and (iii) image-based counting devices for implementing the image processing and counting techniques among other advantages.

### V. Example System Operations

As indicated, various embodiments of the present disclosure make important technical contributions to image processing, object tracking, and object counting techniques. In particular, systems and methods are disclosed herein that implement image-based object detection and counting techniques configured to generate and leverage object-specific denoised images to detect and track targeted objects across multiple image frames. By doing so, some techniques of the present disclosure provide improvements to image processing that may be practically applied in an object counting setting to improve the accuracy, efficiency, and reliability of automated counting devices.

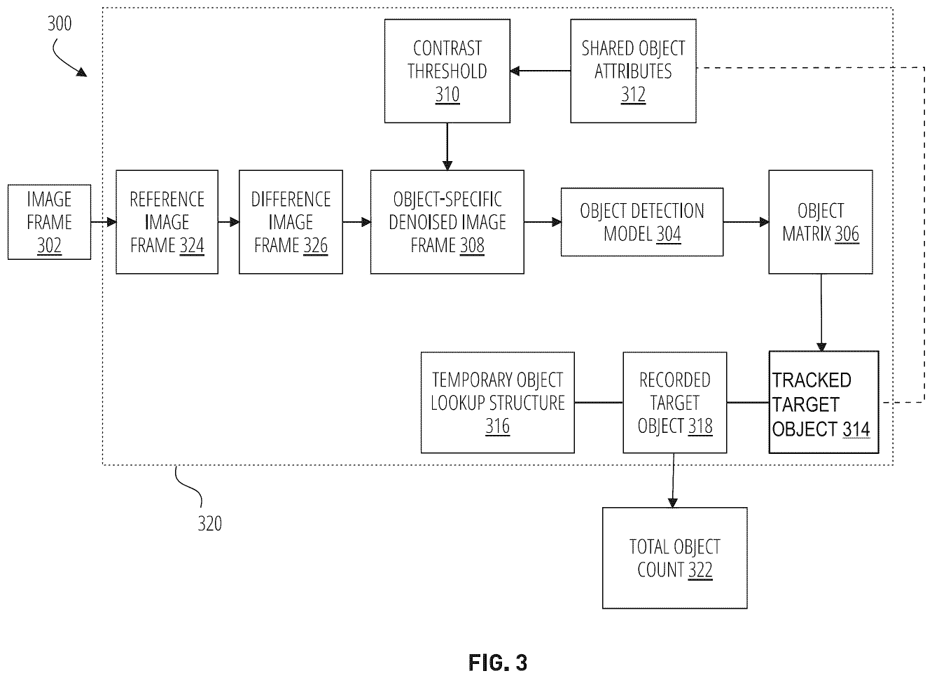

FIG. 3 is a dataflow diagram 300 showing an example object detection and counting technique in accordance with some embodiments discussed herein. The dataflow diagram 300 includes a plurality of data entities involved in an image processing scheme 320 specially designed to detect and track objects within a sequence of image frames. The image processing scheme 320 may receive an image frame 302 from a sequence of image frames (e.g., as the image frames are captured by an image capture device) and modify a total object count 322 based on the image frame 302. In some examples, a plurality of image frames may be captured by one or more image capture devices over a counting time period. Each image frame may be individually processed in accordance with the image processing scheme 320 to modify a total object count 322 based on one or more objects detected across one or more sequences of the plurality of image frames.

In some embodiments, the plurality of image frames are captured by one or more image capture devices of an image-based counting device. An image-based counting device may include a computing device configured to generate a total object count 322 for a plurality of target objects. The image-based counting device may be configured to leverage one or more image capture devices and/or one or more of the techniques of the present disclosure to generate a total object count 322 of a plurality of target objects within a high-speed environment. For instance, the image-based counting device may include a counting chamber and/or one or more image capture devices. The counting chamber, for example, may define a counting environment for the image capture devices. The image capture devices, for example, may include one or more red, blue, green (RBG) cameras, grayscale cameras, black and white cameras, and/or the like. In some examples, the image capture devices may include at least two cameras. Each camera may be configured to independently generate an image frame (and perform one or more operations of the image processing scheme 320) based on one or more calibration attributes for the plurality of target objects.

In some embodiments, an image frame 302 is received from an image capture device. The image frame 302 may be a data entity that describes a recorded image frame from a video sequence. The image frame 302 may correspond to a digital image from a sequence of digital images captured by an image capture device (e.g., of an image-based counting device, etc.) over a counting time period. The image frame 302 may include a plurality of image pixels. Each of the image pixels may be indicative of one or more visual characteristics at a particular point within an environment representation recorded by an image capture device. The one or more visual characteristics may depend on the image capture device. For example, the visual characteristics may include a size, color, position, and/or intensity of a particular point within the environment representation. The color may include a black and/or white color for a black and white image frame captured by a black and white cameras, a monochromatic color for an image frame captured by a grayscale camera, an RGB color for an image frame captured by an RGB cameras, and/or the like.

In some embodiments, the image frame 302 is defined by a relative frame coordinate system, such that each pixel of the plurality of pixels is associated with a respective image position (e.g., relative coordinates, etc.) within the image frame 302. The relative frame coordinates, for example, may include a two dimensional image frame defined by an x, y coordinate system. An image position for a respective image pixel may include a horizontal position (e.g., an x-coordinate, etc.) and/or a vertical position (e.g., a y-coordinate, etc.).

In some examples, the image frame 302 may be indicative of one or more object candidates within a counting environment, such as a counting chamber of an image-based counting device. As described herein, the one or more object candidates may be identified within the image frame 302 to increment a total object count 322 across a plurality of image frames.

In some embodiments, an object-specific denoised image frame 308 is generated for the image frame 302. The object-specific denoised image frame 308 may be generated based on a contrast threshold 310. In some examples, the contrast threshold 310 may be tailored to a target object. By way of example, the contrast threshold 310 may correspond to one or more shared object attributes 312 for the tracked target object 314. The one or more shared object attributes 312, for example, may be indicative of an object consistency, an object color, and/or an object opacity. In some examples, the contrast threshold 310 may be adjusted based on a modification to the one or more shared object attributes.

In some embodiments, an object-specific denoised image frame 308 is a modified image frame that is derived from the image frame 302. The object-specific denoised image frame 308 may include a plurality of image pixels. Each of the image pixels may correspond to an image pixel from the image frame 302. Each of the image pixels, for example, may be an intensified counterpart to a corresponding pixel from the image frame 302. For instance, each of the pixels of the object-specific denoised image frame 308 may be a white pixel (e.g., with an intensity of 255) and/or a black pixel (e.g., with an intensity of 0). In some examples, each pixel from an image frame 302 may be converted to a white pixel and/or black pixel based on a contrast threshold 310 to generate the object-specific denoised image frame 308.

In some embodiments, the contrast threshold 310 is a reconfigurable parameter for generating the object-specific denoised image frame 308. The contrast threshold 310 may be indicative of a threshold pixel intensity for differentiating between a black and white pixel for an object-specific denoised image frame 308. For example, a black pixel may be generated for each pixel of the image frame 302 with an intensity below (and/or equal to) the contrast threshold 310, whereas a white pixel may be generated for each pixel of the image frame 302 with an intensity above (and/or equal to) the contrast threshold 310.

In some embodiments, the contrast threshold 310 is tailored to a particular object type to generate an object-specific denoised image frame 308 that is tailored to the specific attributes of an object. For instance, the contrast threshold 310 may be configured based on one or more shared object attributes 312 for a tracked target object 314. By way of example, the contrast threshold 310 may be increased for a tracked target object 314 with one or more high intensity characteristics, such a brightness (e.g., bright color, reflective coating, etc.), opaqueness (e.g., hard gels, etc.), and/or the like. In addition, or alternatively, the contrast threshold 310 may be decreased for a target object with one or more low intensity characteristics, such a darkness (e.g., dark color, non-reflective coating, etc.), transparency (e.g., soft gels, etc.), and/or the like. In this manner, the contrast threshold 310 may be dynamically tailored to a particular target object to generate an object-specific denoised image frame 308 for specifically highlighting the particular target object, while removing noise from the image frame 302. By doing so, some of the techniques of the present disclosure may improve accuracy of counting machines in high-speed environments by highlighting objects based on their shared characteristics.

In some embodiments, the tracked target object 314 is a data entity that is indicative of an object of interest for an image-based counting device. For example, the tracked target object 314 may be an object for which an image-based counting device is specially configured. The tracked target object 314 may include any type of object and, in some examples, may be based on a prediction domain. By way of example, in a clinical prediction domain, the tracked target object 314 may include a particular pill for which a pill counting machine may be specially configured.

In some embodiments, an object attribute is a data parameter for a tracked target object 314. An object attribute, for example, may be indicative of a characteristic of the tracked target object 314. An object attribute may include an object-specific attribute corresponding to a particular target object identified within the image frame 302. In addition, or alternatively, an object attribute may include a shared object attribute indicative of a common characteristic shared by a plurality of target objects. A shared object attribute, for example, may be generic across each target object of a particular object type, whereas an object-specific attribute may be unique to a particular target object.

In some embodiments, a shared object attribute is indicative of one or more of an average size, an average shape, a dustiness level, and/or one or more other visual characteristics of a particular object type. In some examples, a shared object attribute may be indicative of one or more object characteristics that may impact a visibility of an object within a counting environment. For example, a shared object attribute may include an object consistency, object opacity, object color, and/or the like. By way of example, a shared object attribute may be indicative of an object color, lighting characteristics, such as luminosity, reflectiveness, etc., surface characteristics, such as smoothness, coating, etc., material (e.g., soft gel, hard gel, etc.), manufacturing inconsistency, and/or the like.

In some embodiments, a shared object attribute is predictive of an optimal contrast for highlighting a target object relative to a counting environment. For example, one or more shared object attributes may be leveraged to generate an object-specific denoised image frame for identifying a target object.

In some embodiments, the object-specific denoised image frame 308 is generated based on a comparison between the image frame 302 and a reference image frame 324. For example, the image frame 302 may be compared to the reference image frame 324 to generate a difference image frame 326 that includes a pixel-by-pixel difference between the two frames. The pixel-by-pixel difference between the respective pixels of the two frames may be compared to the contrast threshold 310 to determine an intensity for a corresponding pixel of an object-specific denoised image frame 308. For instance, a white pixel may be generated for each pixel of the object-specific denoised image frame 308 that corresponds to an absolute pixel-by-pixel difference that is below (and/or equal to) the contrast threshold 310. In addition, or alternatively, a black pixel may be generated for each pixel of the object-specific denoised image frame 308 that corresponds to an absolute pixel-by-pixel difference that is above (and/or equal to) the contrast threshold 310. A respective pixel of the object-specific denoised image frame 308, for example, may correspond to an absolute pixel-by-pixel difference between two pixels associated with the same relative coordinates.

The reference image frame 324, for example, may include a stable frame representing a counting environment without an object. The reference image frame 324 may include a preceding image frame captured by an image capture device before a counting time period. The reference image frame 324 may be previously captured by the same image capture device that captures the image frame 302. In some examples, the reference image frame 324 may be periodically updated over time to account for one or more changes to a counting environment. By way of example, the reference image frame 324 may be updated at a refresh frequency that may be indicative of one or more counting time periods (e.g., after a dispensing action, etc.), one or more maintenance time periods (e.g., end of the day, downtime periods, etc.), a predetermined time interval (e.g., every hour, day, week, etc.) a predetermined frame length (e.g., every 100 frames, 400 frames, etc.), and/or the like. In some examples, the refresh frequency may be based on a target object. For instance, the refresh frequency may be based on one or more shared object attributes 312, such as a dustiness, and/or the like, that may impact a visibility of a counting environment.

In some embodiments, an object matrix 306 is generated from the image frame 302. For instance, the object matrix 306 may be generated using an object detection model 304. The object detection model 304 may include a corner detection model configured to identify a plurality of pixels of interest (e.g., corners) based on a plurality of corner points for a tracked target object 314 represented within the image frame 302.

In some embodiments, the object detection model 304 is a data entity that is indicative of parameters, hyper-parameters, and/or defined operations of a rules-based, statistical, and/or machine learning model (e.g., model including at least one of one or more rule-based layers, one or more layers that depend on trained parameters, coefficients, and/or the like). For instance, the object detection model 304 may include a rule-based and/or machine learning model configured to process the image frame 302 to generate an object matrix 306 indicative of a plurality of target object candidates within the image frame 302.

In some embodiments, the object detection model 304 is a corner detection model configured to identify a plurality of pixels of interest from the image frame 302. A corner detection model, for example, may include one or more different types of corner detection models, each configured to identify a pixel of interest based on one or more different initial object detection criteria. A corner detection model, for example, may include an intensity-based model, such as a Harris corner detector, and/or the like, configured to identify a pixel of interest based on a local intensity variation (e.g., a contrast between a pixel's intensity and one or more neighboring pixels' intensities) of the image frame 302. In addition, or alternatively, a corner detection model may include a contour-based model, such as a Canny edge detector, and/or the like, configured to identify a pixel of interest based on a shape of an edge contour. As another example, a corner detection model may include a model-based model configured to identify a pixel of interest by fitting the image frame 302 into a predefined model.

In some embodiments, the object detection model 304 is a machine learning model. For instance, the object detection model 304 may include a machine learning model that is trained to generate an object matrix 306 from an object-specific denoised image frame 308. In some examples, the object detection model 304 may include a machine learning model including one or more supervised, unsupervised, semi-supervised, reinforcement learning models, and/or the like. In some examples, the object detection model 304 may include multiple models configured to perform one or more different stages of a corner detection process. For instance, the object detection model 304 may be configured to extract a plurality of corner points for the tracked target object 314. A plurality of pixels of interest may be generated based on the plurality of corner points for the tracked target object 314.

In some embodiments, the object detection model 304 includes a supervised machine learning model that is trained to generate the object matrix 306 for the image frame 302. By way of example, the object detection model 304 may be trained using one or more supervised machine learning techniques, such as back propagation of errors (e.g., a weighted-fusion layer error propagation, side-output layer error propagation, etc.), and/or the like. The object detection model 304 may include a deep learning model, such as a deep neural network, and/or the like. For instance, the object detection model 304 may include a trimmed convolutional neural network (e.g., very deep convolutional network, etc.) with one or more layers each configured to process the image frame 302 to generate an object matrix 306.

In some embodiments, the object detection model 304 detects one or more of the points of interest of the object matrix 306 based on an intensity of one or more pixels of the image frame 302. To improve the accuracy and granularity of the points of interest extracted from the image frame 302 the image frame 302 may be preprocessed to increase a contrast between pixel intensities of the image frame 302. For example, the image frame 302 may be preprocessed to generate the object-specific denoised image frame 308 including a plurality of black and white pixels. As described herein, the object-specific denoised image frame 308 may be tailored to one or more shared attributes of the tracked target object 314 to increase a contrast between a background and one or more target object candidates within the image frame 302. In this manner, the object detection model 304 may generate an object matrix 306 with a plurality of points of interest at a granular level to improve the differentiation between target object candidates within close proximities to each other (e.g., due to increased movement rates in a high-speed environment, etc.).

In some embodiments, the object matrix 306 is indicative of one or more target object candidates based on the object-specific denoised image frame 308. A target object candidate, for example, may be a data entity that is indicative of a potential object within the image frame 302. A target object candidate may be indicative of a pixel cluster within the image frame 302. In some examples, a pixel cluster may include one or more pixels of interest from the image frame 302 that satisfy one or more initial object detection criteria. For example, the object matrix 306 may be indicative of a plurality of pixels of interest for each of the one or more target object candidates.

In some embodiments, the initial object detection criteria includes computer vision detection criteria leveraged by the object detection model 304 (e.g., an intensity, etc.) configured to extract one or more pixel clusters from the image frame 302. Each target object candidate may correspond to noise within the image frame 302 and/or a tracked target object 314 within the image frame 302.

In some embodiments, the object matrix 306 is a data entity that is indicative of a plurality of target object candidates. An object matrix 306 may include an n-dimensional matrix including a plurality of rows and columns. Each row and/or column may be indicative of a sequence of points of interest for a target object candidate. For instance, each row and/or column may be indicative of a pixel cluster from the image frame 302. In some embodiments, the object matrix 306 is generated for the image frame 302 using the object detection model 304.

In some embodiments, a plurality of object-specific attributes for the one or more target object candidates may be generated based on the object matrix 306. In some embodiments, an object-specific attribute is indicative of one or more of a size, shape, position, and/or the like for a tracked target object 314 identified within the image frame 302. For example, the tracked target object 314 may be defined by a plurality of points of interest (e.g., corner points, etc.) within the image frame 302. The plurality of object-specific attributes may be based on the plurality of pixels of interest. For instance, an object-specific attribute may include one or more characteristics (e.g., coordinates, intensity, etc.) for each of the plurality of points of interest. In addition, or alternatively, an object-specific attribute may include one or more characteristics derived from the plurality of points of interest.

By way of example, an object-specific attribute may be indicative of a target object size. A target object size may be indicative of an area at least partially enclosed by the plurality of points of interest. The area, for example, may be indicative of a number of pixels at least partially enclosed by the plurality of points of interest. In some examples, the area may be based on a distance between an image capture device and a counting environment.

In some examples, an object-specific attribute may be indicative of a center point relative to the plurality of points of interest. In some examples, a center point may be indicative of a position of the tracked target object 314. For instance, a center point may be indicative of a vertical position (e.g., a y-coordinate) and/or a horizontal position (e.g., an x-coordinate) of the tracked target object 314. In some examples, an object-specific attribute may be indicative of one or more contextual characteristics, such as a color, reflectiveness, and/or the like, of the tracked target object 314 (e.g., one or more pixels within an area defined by the plurality of points of interest). In some examples, the plurality of object-specific attributes may be indicative of a center position of the target object. The center position may include one or more image coordinates corresponding to a center point of the tracked target object 314 that are indicative of a vertical position and a horizontal position of an object candidate.

In some embodiments, the tracked target object 314 is identified from the one or more target object candidates based on the plurality of object-specific attributes. For example, tracked target object 314 may be identified based on a comparison between the plurality of object-specific attributes and target detection criteria. By way of example, the plurality of object-specific attributes may be indicative of a number of the plurality of points of interest for the tracked target object 314. In some examples, the tracked target object 314 may be identified based on a first comparison between the number of the plurality of points of interest and a target object corner threshold. In addition, or alternatively, the plurality of object-specific attributes may be indicative of an object size of the tracked target object 314 based on the plurality of points of interest. In some examples, the tracked target object 314 may be identified based on a second comparison between the object size and a target object size threshold. In some examples, the tracked target object 314 may be identified based on a third comparison based on the distance between a recorded object center point and the center point of the tracked target object 314. The recorded object center point, for example, may include may be indicative of a vertical position and/or a horizontal position previously recorded for a recorded object.

In some embodiments, the target detection criteria is a data entity that describes criteria for detecting an object within one or more image frames. Detection criteria may be indicative of one or more object attributes and/or one or more thresholds for identifying the tracked target object 314 within the image frame 302. In some examples, detection criteria may include object-specific detection criteria and/or object-agnostic detection criteria.

In some embodiments, object-agnostic detection criteria is indicative of one or more object attributes for detecting an object of any object type. For example, object-agnostic detection criteria may include a target object corner threshold. A target object corner threshold, for example, may be indicative of a threshold number of points of interest for a target object candidate. The threshold number may include any number of points of interest including three, four, ten, twenty, and/or the like. In some examples, the threshold number may be seven points of interest. In such a case, a target object candidate may be considered a tracked target object 314 in the event that the target object candidate has at least seven points of interest.

In addition, or alternatively, object-agnostic detection criteria may be indicative of one or more image frame characteristics. The image frame characteristics, for example, may be indicative of an image quality (e.g., contrast, dynamic range, spatial resolution, noise, artifacts, etc.) corresponding to the image frame 302. In some examples, the object-agnostic detection criteria may include one or more image quality thresholds for considering the image frame 302.

In some embodiments, object-specific detection criteria are indicative of one or more object attributes for detecting the tracked target object 314 of a particular object type. Object-specific detection criteria may include any combination of the one or more object-specific attributes for a tracked target object 314. In some examples, the object-specific detection criteria may include a threshold value for one or more of the object-specific attributes. By way of example, the object-specific detection criteria may be indicative of a target object size threshold. A target object size threshold, for example, may be indicative of a threshold size (e.g., area, circumference, etc.) for a target object candidate.

In some embodiments, object-specific detection criteria is tailored to a particular type of tracked target object 314. For instance, object-specific detection criteria, such as the target object size threshold, may be based on one or more shared object attributes, as described herein. In some examples, the one or more shared object attributes may be indicative of a minimum size for a plurality of calibration target objects and/or the target object size threshold may be a percentage of the minimum size.

In some embodiments, the object-specific detection criteria (and/or one or more of the shared object attributes) are dynamically determined using a plurality of calibration target objects. A calibration target object may be a target object that is leveraged to determine one or more target detection criteria for calibrating an image-based counting device. A calibration target object may be input to an image-based counting device to generate one or more calibration attributes for the tracked target object 314. A plurality of calibration attributes may be aggregated from a plurality of calibration target objects to determine one or more target detection criteria. For instance, a target object size threshold may include an average size (e.g., number of pixels, etc.) from the plurality of calibration attributes. In addition, or alternatively, the target object size threshold may include a minimum size from the plurality of calibration attributes, an adjusted minimum size from the plurality of calibration attributes, and/or the like. By way of example, a target object size threshold may include a percentage (e.g., seventy-five percent, etc.) of a minimum size recorded for a plurality of calibration target objects.

In some embodiments, a recorded target object 318 corresponding to the tracked target object 314 may be identified based on the plurality of object attributes. In some embodiments, the recorded target object 318 may be identified in response to identifying the tracked target object 314.

In some embodiments, a recorded target object 318 is a data entity that is indicative of the tracked target object 314. A recorded target object 318 may include a temporary data structure that is indicative of one or more object-specific attributes for the tracked target object 314. For example, a recorded target object 318 may include a plurality of recorded object attributes for the tracked target object 314. In some examples, the recorded target object 318 may be stored within a temporary object lookup structure 316 for a predetermined time interval, a frame length, and/or the like.

In some embodiments, a temporary object lookup structure 316 is a data structure in which one or more recorded target objects are temporarily stored. A temporary object lookup structure 316, for example, may include a temporary database, lookup table, and/or the like that is stored in a short-term memory device (e.g., a cache memory, random access memory device, etc.). A temporary object lookup structure 316 may be configured to store a plurality of recorded target objects for a temporary time period. In some examples, the temporary object lookup structure 316 may be configured to store a recorded target object for a frame holdover rate.

In some embodiments, the recorded object attribute is a parameter for a recorded target object 318. A recorded object attribute may be indicative of an object-specific attribute for an identified target object. In addition, or alternatively, a recorded object attribute may be indicative of a storage attribute for the recorded target object 318 A storage attribute may be indicative of a detection timestamp (e.g., a time at which a target object is detected), a detection duration (e.g., a time duration after a target object is detected), a detection image frame (e.g., an image frame at which a target object is first detected), an image frame length, and/or the like.

In some embodiments, an image frame length is a storage attribute that is indicative of a storage duration for the recorded target object 318. An image frame length may be indicative of a number of image frames. For instance, an image frame length may be indicative of an image frame count from a detection image frame for the recorded target object 318. For example, an image frame length may be indicative of a number of image frames subsequent to and/or including the detection image frame. By way of example, the plurality of recorded object attributes may be indicative of an image frame length that is indicative of a number of image frames processed subsequent to a generation of the recorded target object 318. In some examples, the temporary object lookup structure 316 may be modified to remove the recorded target object 318 in response to the image frame length satisfying a frame holdover threshold.

In some embodiments, the frame holdover threshold is to a threshold that is indicative of a storage duration constraint for a recorded target object 318. For example, a frame holdover threshold may be indicative of a threshold image frame length for which a recorded target object 318 may be stored within a temporary object lookup structure. By way of example, a frame holdover threshold may be indicative of a maximum number of frames (e.g., two, five, ten, twenty, etc.) for which a recorded target object 318 may be stored. In some examples, the frame holdover rate may be indicative of five image frames. In some examples, a recorded target object 318 may be removed from a temporary object lookup structure in the event that an image frame length exceeds a frame holdover threshold.

In some embodiments, an object-specific count for the recorded target object 318 is modified based on the tracked target object 314. For instance, the object-specific count may be modified in response to identifying the tracked target object 314 within the image frame 302. In addition, or alternatively, the object-specific count may be modified in response to identifying a matching recorded target object 318 for the tracked target object 314.

In some embodiments, the object-specific count is a recorded object attribute that is indicative of a number of object detections for the tracked target object 314 corresponding to a recorded data object. An object-specific count, for example, may be indicative of a number of image frames in which the tracked target object 314 is identified. In some examples, an object-specific count may be indicative of one or more particular image frames (e.g., an image frame number, etc.) in which the tracked target object 314 is identified.

In some embodiments, the total object count 322 is modified in response to the object-specific count satisfying a threshold detection count. The total object count 322 may be a data entity that is indicative of a number of target objects identified during a counting time period. In some examples, the total object count 322 may be indicative of a total number of target objects dispensed by an image-based counting device over the counting time period.

In this manner, a plurality of objects of interest may be identified and reliably counted across a plurality of image frames in a high-speed counting environment using an image-based counting device. The techniques of the present disclosure may be implemented in any counting environment by any image-based counting device. In some examples, the image-based counting device may include a pill counting machine configured to automatically dispense a particular number of controlled substances (e.g., medicines, etc.). An example image-based counting device will now further be described with reference to the following figures.

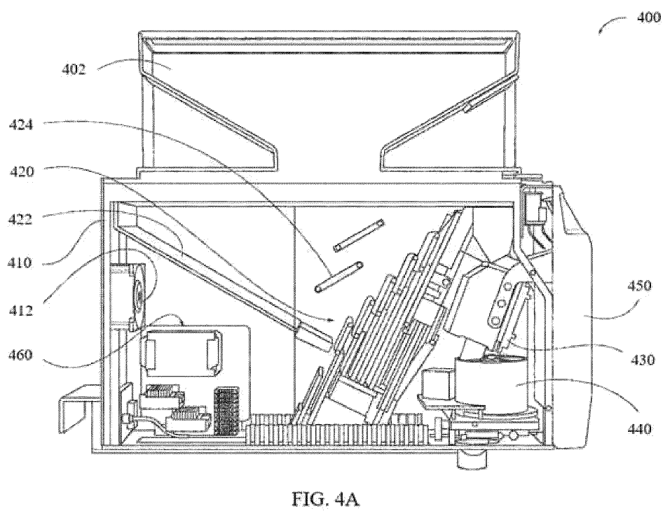

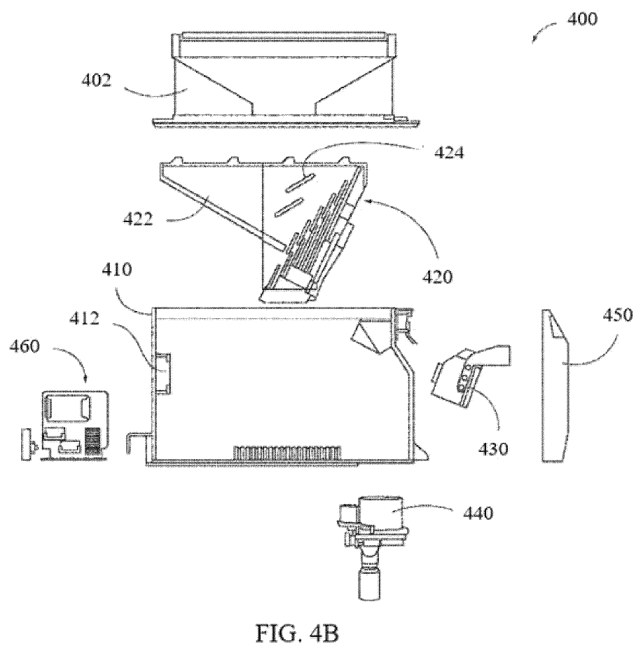

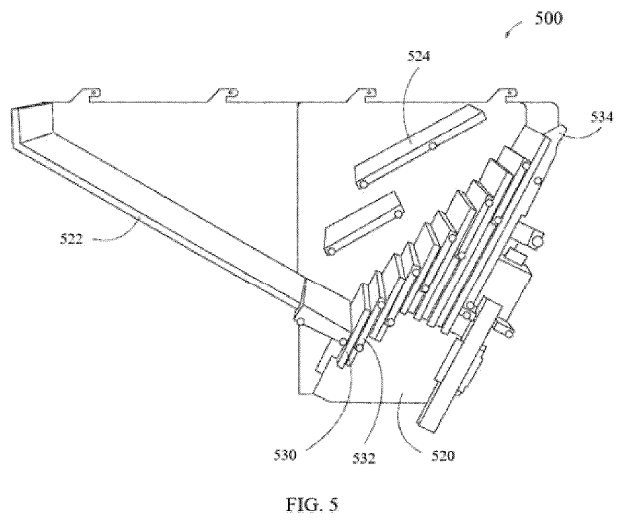

FIGS. 4A-B are operational examples of an image-based counting device 400 in accordance with some embodiments discussed herein. FIG. 4A depicts the device 400 assembled and FIG. 4B depicts the device 400 with various components isolated. The device 400 includes a loading hopper 402 connected to a housing 410. The housing 410 includes a cooling fan 412, a singulation mechanism 420, a count chamber 430, an indexer unit 440, a display 450, and a control system 460. In some examples, the control system 460 may include one or more processors and/or memory devices configured to perform one or more operations of the present disclosure to count the provided objects.

In some embodiments, the image-based counting device 400 is configured to move a plurality of objects to improve a total object count. For instance, the image-based counting device 400 may include a loading hopper 402 that may provide objects (e.g., pills, etc.) to be counted into the singulation mechanism 420. The singulation mechanism 420 may be configured to receive and singulate objects from a loading hopper 402 to improve a differentiation of the objects through image frames. The singulation mechanism 420 may include a sloped portion 422 configured to cause objects to flow toward the step mechanism and/or configurable baffles 424 configured to control a flow of objects to the step mechanism.

The singlulated objects may drop through the count chamber 430 (e.g., counting environment, etc.) into the indexer unit 440. The count chamber 430 may include one or more image capture devices that capture a plurality of image frames (e.g., environment representations, etc.) of the objects as they pass through the count chamber 430. The image frames may be analyzed, in accordance with some of the techniques of the present disclosure, to identify and track an object as the object falls through the count chamber 430. If an identified object satisfies target detection criteria, a total object count may be incremented.

The indexer unit 440 may receive and retain a container (e.g., pill bottle, vial, etc,) under the indexer unit 440. When the object container is in place, the indexer unit 440 may open a bottom gate to allow objects to fall into the container. In some examples, a predetermined count of objects may be temporarily stored in a compartment of the object retainer of the indexer unit 440, and the bottom gate of the indexer unit 440 may open to pass the temporarily stored predetermined count of objects from the compartment into the container when the container is in place to receive the objects. In some examples, the indexer unit 440 may be selectively removable to facilitate direct filling of a container without temporary storage. For example, counted objects may pass directly through count chamber 430 and a tube (not shown) may be installed in place of the indexer unit 440 into the container when the indexer unit 440 is removed. In some examples, the tube may be an extended version of the tube in the count chamber 430.

The control system 460 may control output devices, such as switches, solenoids, actuators, etc. The control system 460 may further monitor various input devices, such as image capture devices, level indicators, position indicators, etc. In some examples, the control system 460 may include a memory configured to store executable instructions, and one or more processors (e.g., a microcontroller, a central processor unit, or other type of processing unit) configured to execute the executable instructions to control operation of various components of the image-based counting device, including controlling the image capture devices, determining object attributes of objects that fall through the count chamber 430, analyzing images to determine whether to increment a total object count, detecting problems with the image-based counting device, driving a user interface, and/or the like. In some examples, the control system 460 includes a programmable logic controller (PLC) configured to be programmed to control or perform methods or operations described herein. While the control system 460 is depicted in FIGS. 4A and 4B as being co-located in a single location, certain portions of the control system 460 may be located elsewhere within the device 400.

In some examples, the device 400 may include the display 450 with a user interface configured to provide operational information, provide alerts or warnings regarding problems with the image-based counting device, receive user input to set or change one or more configurable parameters (e.g., step feeder speed, calibration attributes, target detection criteria, camera frame rates, target object count information, etc.). In some examples, the device 400 may include a communication interface (e.g., wired or wireless, direct or network-based) configured to provide operational information, receive target object counts, receive information to set or adjust configurable parameters (e.g., step feeder speed, calibration attributes, target detection criteria, camera frame rates, target object count information, etc.), and/or the like, to a remote device. In some examples, some portions of the control system 460 corresponding to the display may be positioned proximate to the display 450. For example, as part of the control system 460, the display 450 may include a system-on-module (SOM) (e.g., having a memory and/or one or more processors for storing and executing instructions to perform various operations described herein. In other examples, the SOM may be separate from the display 450, but may be mounted behind the display 450. In some examples, the SOM may control operations of the image capture devices including the frame rate, as well as may execute an algorithm to decipher targets that call through the count chamber 430 for counting.

The loading hopper 402 may be configured to receive a bulk quantity of objects to be distributed in prescribed quantities to individual containers. The loading hopper 402 may gravity-feed objects into the singulation mechanism 420 via one or more openings or apertures in the housing 410. In some examples, the one or more openings or apertures may include a gate mechanism that may be opened or closed to control provision of the objects from the loading hopper 402 to the singulation mechanism 420.

FIG. 5 depicts a singulation mechanism 500 for an example image-based counting device in accordance with embodiments of the disclosure. The singulation mechanism 500 may include a step feeder and/or any other means for singulating a plurality of objects. A step feeder, for example, may include a sloped member 522 configured to direct objects from a loading hopper toward a movable step mechanism 520. In some examples, a step feeder may further include adjustable baffles 524 configured to further control the flow of objects toward the movable step mechanism 520.

The movable step mechanism 520 may include a set of moveable slats 530 that are situated in an approximately vertical (e.g., angled at less than 45 degrees from a vertical reference) orientation. The top platform of each of the set of moveable slats 530 may be vertically offset from one another such that they form a step or stair-like arrangement, and work together to move objects from a lower position to an upper position, where they are fed into a counting environment, such as the counting chamber described herein. The set of moveable slats 530 may be interleaved with a set of fixed slats 532, such that each of the moveable slats 530 are slotted between respective upper and lower fixed slats 532. The top platform of each slat of the set of moveable slats 530 has a range of motion from even with (or slightly below) a top platform of the respective lower fixed slat 532 to even with (or slightly above) a top platform of the upper fixed slat 532. The top platform of each of the set of moveable slats 530 may have a width and a depth to accommodate a single row of one or more objects. The top platform of each of the fixed slats 532 may provide a ledge to hold a row of objects until the next moveable slat 530 is lowered to receive the next set of objects. In some examples, the top slat 534 of the series of moveable slats 530 may be configured to be selectively changed, either via the use of an expandable slat (physically or electronically or via the replacement of one slat with another) based on a size of object to be counted. The top slat 534 in the set of moveable slats 530 may interface with an angled member to allow the objects to fall from the top slat 534 into the count chamber in a cascading manner (e.g., the objects fall at different times such that they generally fall through the count chamber one at a time).

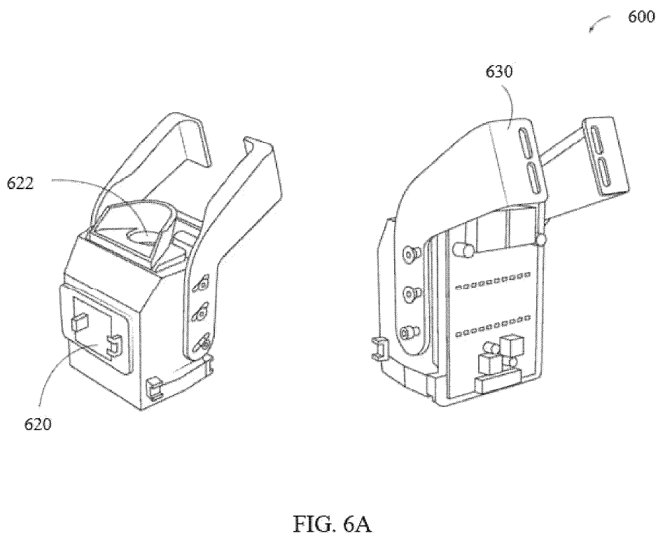

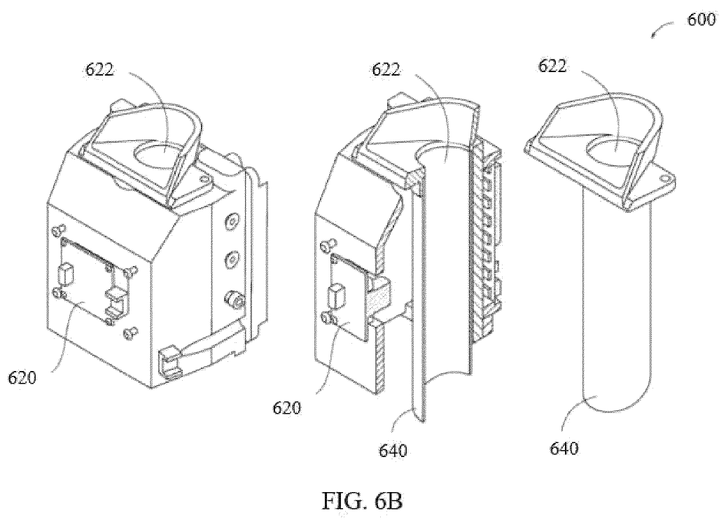

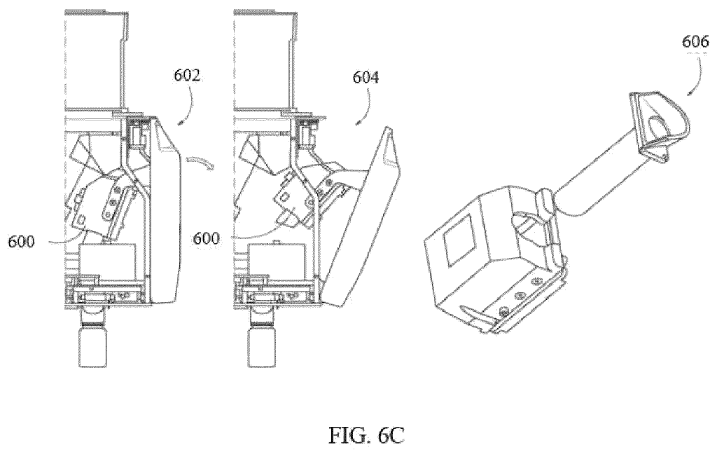

FIGS. 6A to 6C depict various views of an example counting environment 600 in accordance with some embodiments discussed herein. The counting environment 600, for example, may include a counting chamber with at least one image capturing device 620 (camera, etc.) configured to capture a plurality of image frames indicative of at least a portion of the counting environment 600 and/or one or more objects falling through the counting environment 600. For example, a count chamber may include an opening 622 in a tube 640. The image frames may be indicative of a plurality of objects falling through the opening 622 in the tube 640. In some examples, the counting environment 600 may include a backlight and/or other light source, such as a direct light, and/or the like, to illuminate the objects as they fall through the counting environment 600. In some examples, the counting environment 600 may include mounting brackets 630 to mount the counting environment 600 in an image-based counting device.

In some embodiments, a plurality of image frames are generated by one or more image capture devices as a plurality of objects fall through the counting environment. Using some of the techniques of the present disclosure, one or more object-specific attributes of an object may be determined, on a frame-by-frame basis, as the object falls through the tube 640. As described herein, in the event that one or more object-specific attributes satisfy one or more target detection criteria (e.g., area, length, width, depth, color, shape, opaqueness, etc.), a target object may be identified. The target object may be tracked across a plurality of image frames and a total object count may be incremented only if the target object is identified across a threshold number of the plurality of image frames. In some embodiments, the target detection criteria is set through interaction with a user interface, such as an interactive display screen, a microphone, and/or the like.

In some embodiments, the tube 604 is removable for changing sizes, cleaning, maintenance, and/or the like. In some examples, the tube 640 may be transparent and may be selectively removed for cleaning, replacement, and/or the like to maintain the transparency of the tube 640. The mounting brackets 630 may be arranged to allow the counting environment 600 to be removed from an object counter, such as for maintenance, and/or the like. For example, as shown steps 602, 604, and 606 of FIG. 6C, the mounting brackets 630 may be mounted to a front panel of the image-based counting device, and as the front panel is removed, the counting environment 600 may also be removed from the image-based counting device.

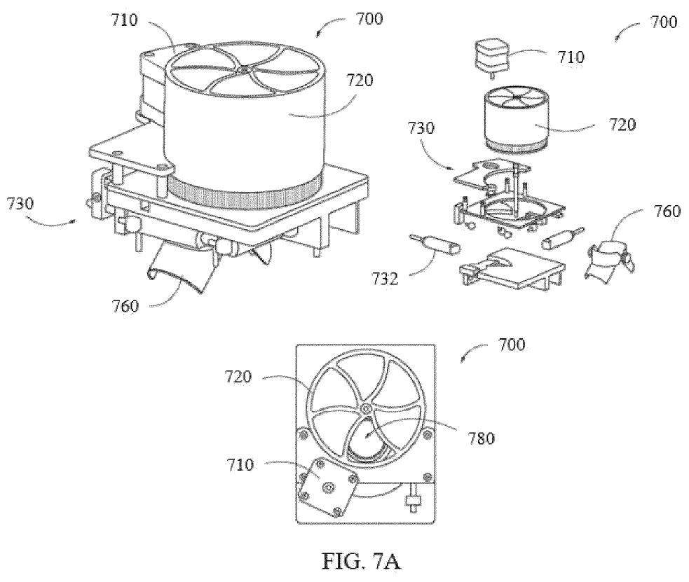

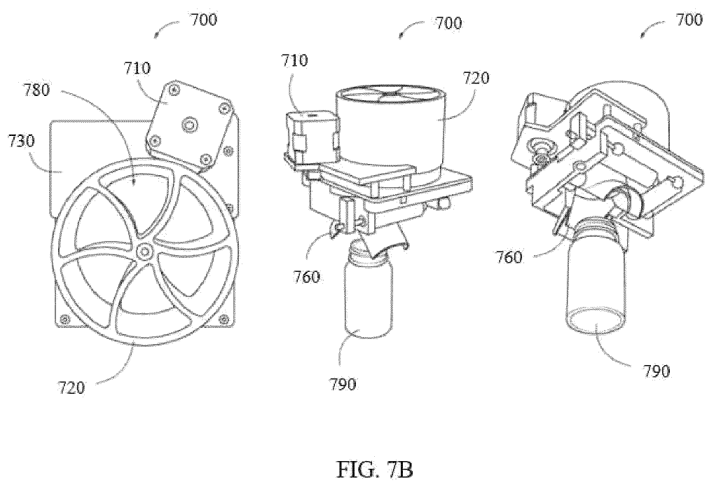

FIGS. 7A and 7B depict various views of an example indexer unit 700 in accordance with some embodiments discussed herein. The indexer unit 700 may include a motor 710, an object retainer 720, a release mechanism 730, and a container retainer 760.

In some embodiments, the indexer unit 700 is configured to receive objects that have fallen through the counting environment and to route them to a container 790 (e.g., bottle, vial, etc.) for holding objects. In some examples, the indexer unit 700 may include the object retainer 720 configured to temporarily hold objects that have fallen through the counting environment. In some examples, the object retainer 720 may be circular, and may include vertical dividers to form multiple compartments 780 in the object retainer 720. The container retainer 760 may retain the container 790 and the release mechanism 730 may release objects into the retained container 790. In some examples, the release mechanism 730 may include an actuator 732 that selectively moves the gate to cover or expose an opening in a bottom of the object retainer 720 that allows objects to fall through into the retained container 790. In some examples, the container 790 may be retained directly below the counting environment. In some modes of operation, the actuator 732 may hold the gate open such that the objects fall directly through from the counting environment and into the container 790 without being temporarily retained.

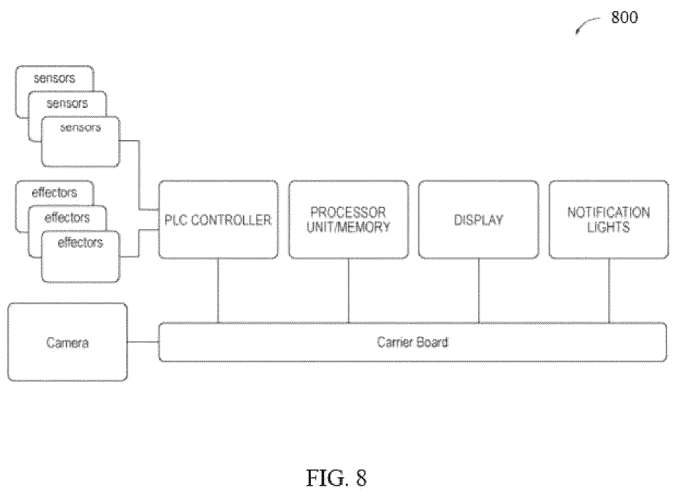

FIG. 8 depicts a block diagram of a control system 800 for an image-based counting device in accordance with some embodiments of the disclosure. The control system 800, for example, may include an example processing computing entity 102 as described with reference to FIGS. 1 and 2. The control system 800 may include various sensors to sense operational status of the object counting device, various effectors to control states of various components of the object counting device, a PLC controller, a processor unit and memory to control operation of the object counting device, a display with a user interface, notification lights, a carrier board to provide communication between a camera and other components of the control system 800.

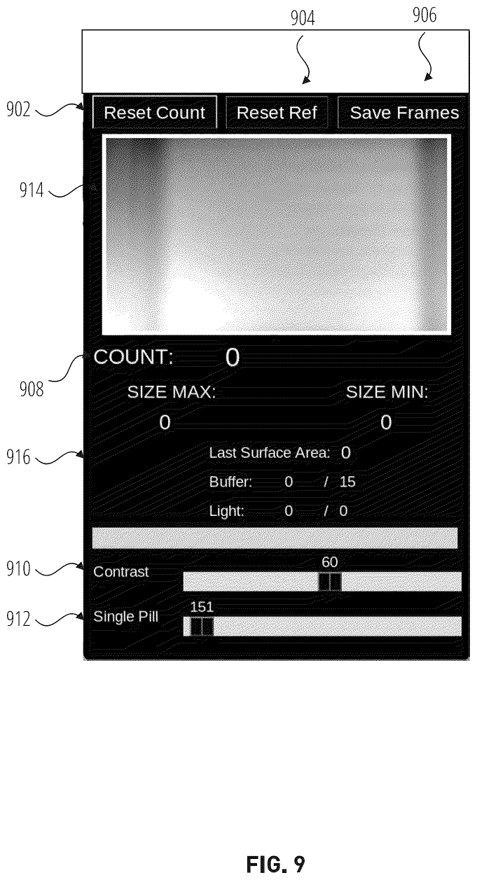

In some examples, the display, the processor unit and memory, and the notification lights may be configured to provide a user interface. As an example, FIG. 9 depicts an example user interface screenshot 900 for the image-based counting device. The user interface example 900 depicts a plurality of interactive icons and contextual information sub screens.

The plurality of interactive icons may include a count reset icon 902, a reset reference icon 904, a save icon 906, a contrast threshold icon 910, a size threshold icon 912, among others. The count reset icon 902 may include an interactive widget that, in response to a detected user input, may initiate a zeroing (or other resetting process) for a current total object count. The reset reference icon 904 may include an interactive widget that, in response to a detected user input, may initiate a generation (e.g., by capturing a current image frame, etc.) of a new reference image frame based on a current state of a counting chamber. The save icon 906 may include an interactive widget that, in response to a detected user input, may initiate a storage (or other saving process) of one or more image frames (e.g., a current image frame, a set of image frames within a time duration, etc.). The contrast threshold icon 910 may include an interactive widget that, in response to a detected user input, may manually modify a contrast threshold. The size threshold icon 912 may include an interactive widget that, in response to a detected user input, may manually modify a target object size threshold. For instance, the contrast threshold and/or target object size threshold may be automatically determined (e.g., based on shared object attributes) or manually determined and/or modified using the contrast threshold icon 910 and/or size threshold icon 912. The contrast threshold icon 910 and/or size threshold icon 912, for example, may include one or more sliding icons that may be moved, responsive to user input, to incrementally increase or decrease a respective threshold. The contextual information sub screens may include an image sub screen 914, a count sub screen 908, and/or one or more contextual object sub screens 916. The image sub screen 914, for example, may reflect an image frame and/or object-specific denoised image frame. In some examples, the image sub screen 914 may reflect a plurality of sequential image frames and/or object-specific denoised image frames in real or near real time as they are generated and/or captured. The count sub screen 908 may reflect a current total object count. The count sub screen 908 may be updated in real or near real time to reflect a current total object count. The contextual object sub screens 916 may reflect one or more object-specific attributes (e.g., a last surface area, etc.) and/or shared object attributes (e.g., max size, min size, etc.) associated with a plurality of objects that are detected over a time range.

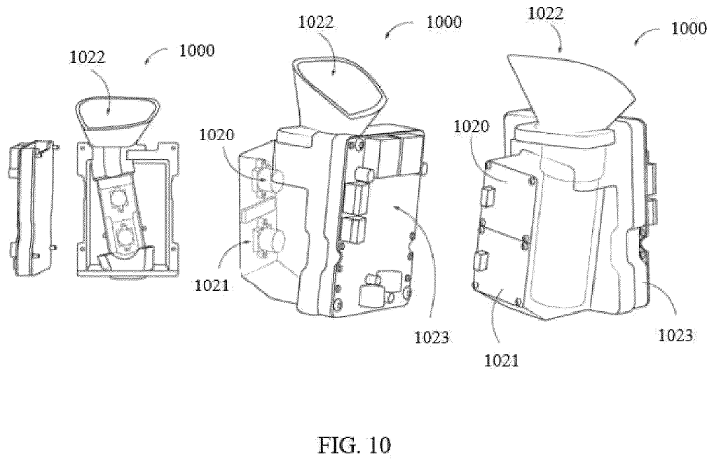

FIG. 10 depicts various views of a dual-camera count chamber 1000 in accordance with some embodiments discussed herein. The dual-camera count chamber 1000 may include a pair of image capture devices (e.g., cameras, etc.). The pair of image capture devices, for example, may include a first image capture device 1020 and/or a second image capture device 1021. The first image capture device 1020 and/or the second image capture device 1021 may be configured to capture image frames indicative of one or more objects falling through an opening 1022 in the dual-camera count chamber 1000.

In some examples, the first image capture device 1020 and/or the second image capture device 1021 may be mounted in different vertical planes (e.g., mounted vertically with respect to one another). In some examples, the first image capture device 1020 and/or the second image capture device 1021 may be mounted in a common horizontal plane, such that the first image capture device 1020 may be mounted directly above the second image capture device 1021 on the dual-camera count chamber 1000. In some examples, the dual-camera count chamber 1000 may include a backlight or other light source 1023 (such as a direct light) to illuminate the objects as they fall through the dual-camera count chamber 1000. In some examples, the first image capture device 1020 and/or the second image capture device 1021 may share the same backlight system 1023. In some examples, the count chamber 430 of FIGS. 4A and 4B may implement the dual-camera count chamber 1000.

In some embodiments, the first image capture device 1020 and/or the second image capture device 1021 are configured to independently capture image frames of a counting environment (and/or one or more portions/perspectives thereof). Each of the image frames may be processed to independently identify and/or track target objects in accordance with some of the techniques of the present disclosure. In some examples, each image frame may be processed based on characteristics of an image capture device that captured the image frame. By way of example, the first image capture device 1020 and/or the second image capture device 1021 may view the counting environment from one or more different perspectives, such as one or more different angles, one or more different distances, and/or the like. In some examples, the shared object attributes, the target detection criteria, contrast threshold, and/or the like may be based on the perspective on a position, perspective, and/or one or more imaging characteristics of a respective image capture device. By way of example, a target object size threshold may be based on a distance between an image capture device and the counting environment.

In some embodiments, image frames from the first image capture device 1020 and/or the second image capture device 1021 are leveraged to verify a total object count for the object. For example, the image frames from the first image capture device 1020 and/or the second image capture device 1021 may be processed independently of one another to generate a total object count from a plurality of image frames captured by each of the image capture devices. For instance, a total object count may include (i) a first total object count generated based on a plurality of image frames captured by the first image capture device 1020 and/or (ii) a second total object count generated based on a plurality of image frames captured by the second image capture device 1021. In some examples, in the event that the first total object count is different from the second total object count, the lower of the two counts may be selected as an official count. If the count difference between the first and second total object counts exceeds an error threshold (e.g., a difference or discrepancy of three or more objects), a fault may be triggered to flag a count for an additional verification operation (e.g., manual verification, etc.).

In some examples, the first and second object counts may both be sent from the image-based counting device 400 to a pharmacy control system, and the pharmacy control system may address counter discrepancies, including selecting a lower one of the object counts and/or triggering a fault if the count discrepancy exceeds the error threshold. When the pharmacy control system detects a fault, the container being filled may be routed to an exception processing location.

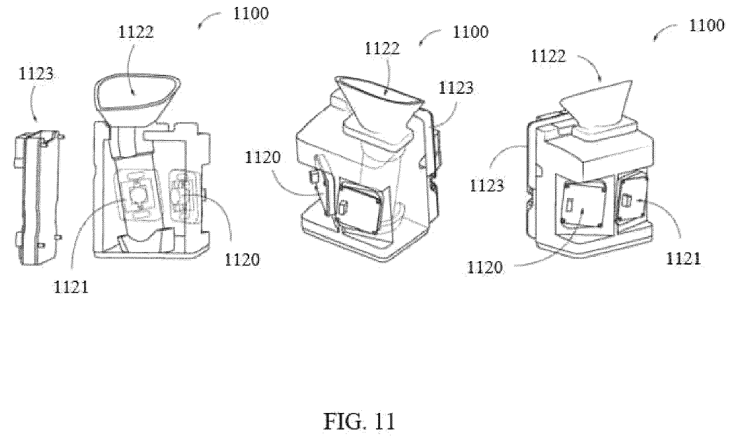

FIG. 11 depicts various views of a dual-camera count chamber 1100 in accordance with some embodiments discussed herein. The dual-camera count chamber 1100 may include a pair of image capture devices (e.g., cameras, etc.). The pair of image capture devices, for example, may include a first image capture device 1120 and/or a second image capture device 1121. The first image capture device 1120 and/or the second image capture device 1121 may be configured to capture image frames indicative of one or more objects falling through an opening 1122 in the dual-camera count chamber 1100.

The image capture devices may be mounted in different horizontal planes (e.g., mounted horizontally with respect to one another). In some examples, the image capture devices may be mounted in a common vertical plane, such that the first image capture device 1120 is mounted horizontally adjacent to the second image capture device 1121 on the dual-camera count chamber 1100. In some examples, the image capture device may be mounted less than 90 degrees apart around the opening 1122. In some examples, the image capture devices may be mounted between and including 45 and 75 degrees apart around the opening 1122. In some examples, the image capture devices may be mounted approximately 60 degrees apart around the opening 1122. In some examples, the dual-camera count chamber 1100 may include a backlight or other light source 1123 (such as a direct light) to illuminate the objects as they fall through the dual-camera count chamber 1100. In some examples, the image capture devices may share the same backlight system 1123.

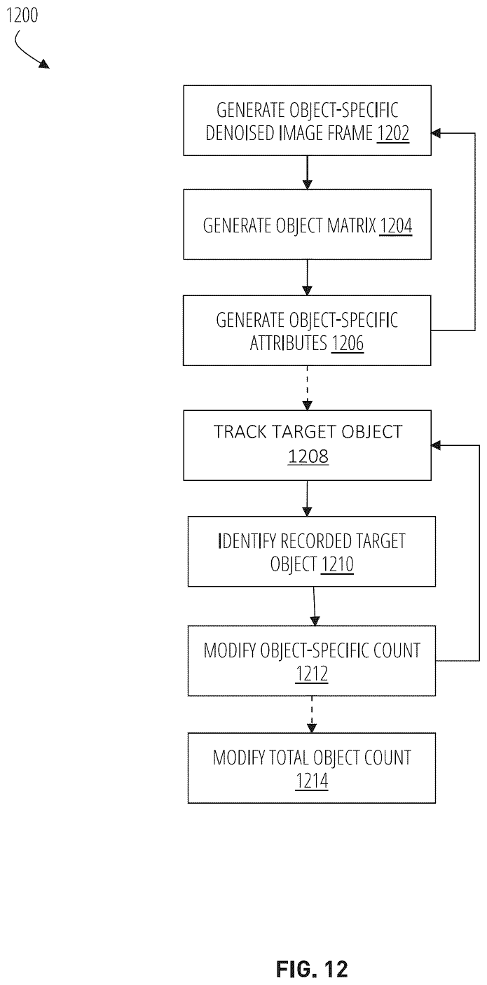

FIG. 12 is a flowchart showing an example of a process for detecting and tracking an object in a high-speed environment in accordance with some embodiments discussed herein. The flowchart depicts an image-based object tracking and counting technique that overcomes various limitations associated with traditional object counting techniques. The image-based object tracking and counting technique may be implemented by one or more computing devices, entities, and/or systems described herein. For example, via the various steps/operations of the process 1200, the computing system 100 (e.g., an image-based counting device thereof) may generate and leverage an object-specific denoised image frame to identify target objects across a plurality of image frames to improve accuracy and accountability of object counting relative to traditional techniques.

FIG. 12 illustrates an example process 1200 for explanatory purposes. Although the example process 1200 depicts a particular sequence of steps/operations, the sequence may be altered without departing from the scope of the present disclosure. For example, some of the steps/operations depicted may be performed in parallel or in a different sequence that does not materially impact the function of the process 1200. In other examples, different components of an example device or system that implements the process 1200 may perform functions at substantially the same time or in a specific sequence.

In some embodiments, the process 1200 includes, at step/operation 1202, generating an object-specific denoised image frame. For example, the computing system 100 may generate the object-specific denoised image frame for an image frame based on a contrast threshold corresponding to one or more shared object attributes for a target object. The one or more shared object attributes, for example, may be indicative of an object consistency, an object color, and/or an object opacity. In some examples, the computing system may modify the contrast threshold based on a modification to the one or more shared object attributes.

In this manner, the process 1200 may provide one or more technical improvements over traditional image-based tracking techniques. For instance, by generating an object-specific denoised image frame tailored to the specific characteristics of a target object, some of the techniques of the present disclosure may improve the identification of an object within image representations of a counting environment. This, in turn, allows for the reliable detection and tracking of objects across image frames in a high-speed environment. Moreover, by tailoring a contrast threshold to the shared attributes of an object, some of the techniques of the present disclosure provide improvements to image processing that enable denoising operations to be tailored to a particular object. In this manner, an object-specific denoised image frame may be generated that highlights specific objects while deemphasizing noise, such as dust, and/or the like, that may be prevalent and/or change over time in a counting environment, such as a counting chamber.

In some embodiments, the process 1200 includes, at step/operation 1204, generating an object matrix based on the object-specific denoised image frame. For example, the computing system 100 may generate, using an object detection model, an object matrix indicative of one or more target object candidates based on the object-specific denoised image frame. The object matrix may be indicative of a plurality of points of interest for each of the one or more target object candidates. For instance, the object detection model may include a corner detection model. The plurality of points of interest may be based on a plurality of corner points extracted for the one or more target object candidates.

In some embodiments, the process 1200 includes, at step/operation 1206, generating object-specific attributes. For example, the computing system 100 may generate a plurality of object-specific attributes for the one or more target object candidates based on the object matrix. For instance, the plurality of object-specific attributes may be based on the plurality of points of interest. In some examples, the plurality of object-specific attributes may be indicative of a number of the plurality of points of interest and/or an object size for each of the one or more target object candidates. By way of example, the plurality of object-specific attributes may be indicative of a number of the plurality of points of interest for the target object and/or an object size of the target object based on the plurality of points of interest. In some examples, the plurality of object-specific attributes may be indicative of a center position of a target object. A center position may include one or more image coordinates corresponding to a center point of the target object. The center position may be indicative of a vertical position and/or a horizontal position of a target object candidate.

In some embodiments, the one or more object-specific attributes for at least one of the one or more target object candidates may be indicative of a target object. In such a case, the process 1200 may proceed to step/operation 1208. Otherwise, the process 1200 may return to step/operation 1202 for processing a subsequent image frame.

In some embodiments, the process 1200 includes, at step/operation 1208, tracking a target object. For example, the computing system 100 may identify the target object from the one or more target object candidates based on the plurality of object-specific attributes. For instance, the computing system 100 may identify the target object based on a first comparison between an object size and a target object size threshold, a second comparison between the number of the plurality of points of interest and a target object corner threshold, and/or a third comparison based on a distance between a recorded object center point and a center point of the tracked target object 314. In some examples, the target object size threshold may be based on the one or more shared object attributes. For example, the one or more shared object attributes may be indicative of a minimum size for a plurality of calibration target objects and the target object size threshold may be a percentage (e.g., sixty percent, seventy-five percent, etc.) of the minimum size.

In some embodiments, the process 1200 includes, at step/operation 1210, identifying a recorded target object. For example, the computing system 100 may record the recorded target object corresponding to the target object based on the plurality of object attributes in response to identifying the target object. For instance, the recorded target object may be stored within a temporary object lookup structure. The plurality of recorded object attributes may be indicative of a recorded object size, a recorded object vertical position, and/or an object-specific count. In some examples, the recorded target object may be identified based on a first comparison between the recorded object size and the object size of the target object, a second comparison between the recorded vertical position and the vertical position of the target object, and/or a third comparison based on the distance between a recorded object center point and a center point of the tracked target object 314.

In some embodiments, the process 1200 includes, at step/operation 1212, modifying an object-specific count. For example, the computing system 100 may modify the object-specific count for the recorded target object in response to identifying the recorded target object corresponding to the target. In some examples, the plurality of recorded object attributes may be indicative of an image frame length. The image frame length may be indicative of a number of image frames processed subsequent to a generation of the recorded target object. In some examples, the computing system 100 may modify the temporary object lookup structure to remove the recorded target object in response to the image frame length satisfying a frame holdover threshold.

In some embodiments, the object-specific count may satisfy a threshold detection threshold. In such a case, the process 1200 may proceed step/operation 1214. Otherwise, the process 1200 may return to step/operation 1208 for processing another target object.

In some embodiments, the process 1200 includes, at step/operation 1214, modifying a total object count. For example, the computing system 100 may modify a total object count in response to the object-specific count satisfying a threshold detection count. The threshold detection count, for example, may be at least two.

Some techniques of the present disclosure enable the generation of action outputs that may be performed to initiate one or more actions to achieve real-world effects. The image-based object tracking and counting techniques of the present disclosure may be used, applied, and/or otherwise leveraged to generate accurate, reliable, and quick object counts in a high-speed environment, such as in a large scale distribution setting. These outputs may be leveraged to initiate the performance of various computing tasks that improve the performance of a computing system (e.g., a computer itself, etc.) with respect to various actions performed by the computing system 100.

In some examples, the computing tasks may include actions that may be based on the setting in which the image-based object tracking and counting techniques are used. For instance, the image-based object tracking and counting techniques may be used in any environment in which computing systems may be applied to achieve real-word insights, such as object counts, and initiate the performance of computing tasks, such as actions (e.g., alerts, etc.), to act on the real-world insights. These actions may cause real-world changes, for example, by controlling a hardware component (e.g., to disable an image-based counting device, etc.), providing condition alerts (e.g., to flag a container, etc.), and/or the like.

Example settings may include financial systems, clinical systems, autonomous systems, robotic systems, and/or the like. Actions in such settings may include the initiation of automated instructions across and between devices, automated notifications, automated maintenance scheduling operations, automated precautionary actions, automated security actions, and/or the like.

In some embodiments, the image-based object tracking and counting techniques are applied to initiate the performance of one or more actions. An action may depend on the setting. In some examples, the computing system 100 may leverage the image-based object tracking and counting techniques to precisely count a number of objects, such as regulated objects including pills, and/or the like, that are dispensed by the image-based counting device. A total object count may be leveraged to automatically monitor and control the dispensation of a plurality of different objects in a plurality of different containers over an operational time period. Moreover, the data indicative of total object count, and/or the like, may be displayed as a visual rendering to illustrate a number of dispensed objects in real time. In some examples, the visual rendering may be indicative of a respective image frame, a denoised image frame, and/or a target object within the image frame.

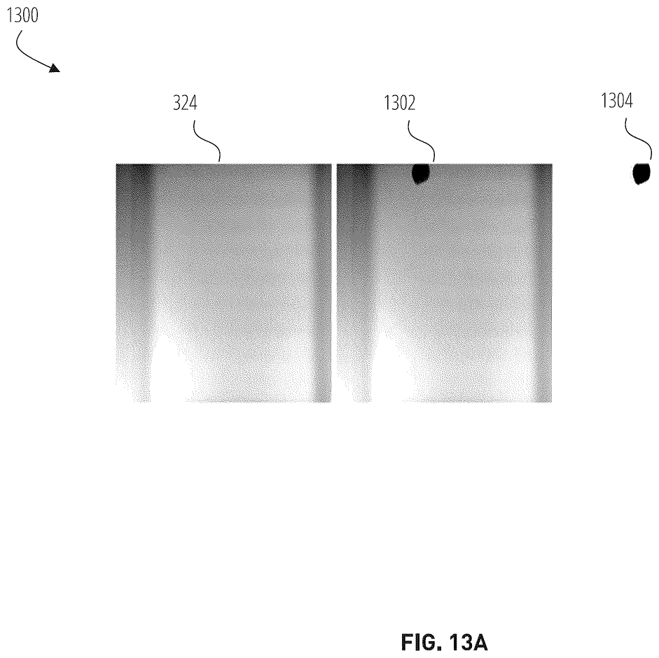

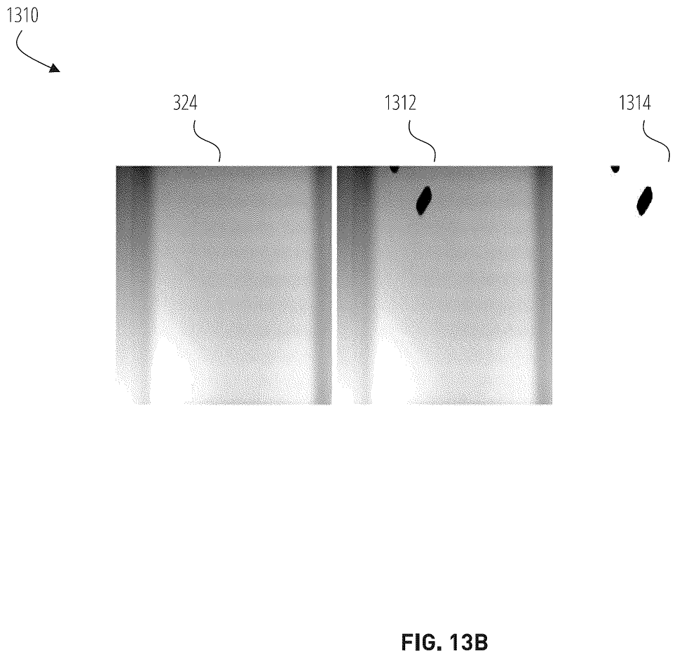

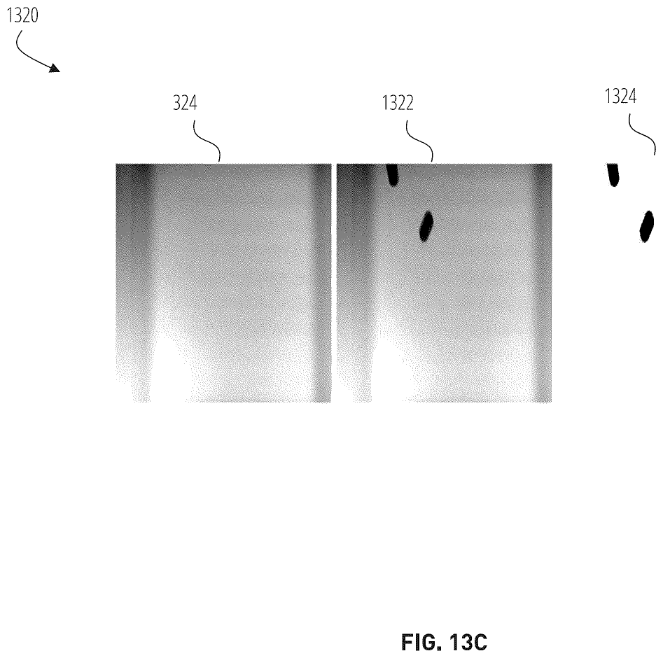

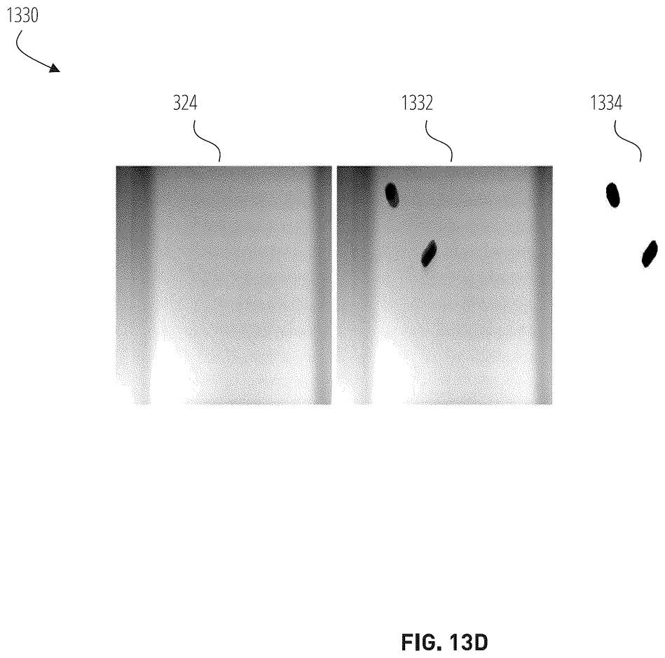

FIGS. 13A-D depict example image frames in accordance with some embodiments discussed herein. For example, FIG. 13A depicts a first set of image frames 1300 at a first-time step of a counting operation. The first set of image frames 1300 may include reference image frame 324, a first image frame 1302, and a first denoised image frame 1304. FIG. 13B depicts a second set of image frames 1310 at a second-time step of a counting operation that is subsequent to the first-time step (e.g., as an object falls through a counting chamber). The second set of image frames 1310 may include the reference image frame 324 (e.g., the same reference image frame may be used until reset), a second image frame 1312, and a second denoised image frame 1314. FIG. 13C depicts a third set of image frames 1320 at a third-time step of a counting operation that is subsequent to the second time (e.g., as an object continues to fall through the counting chamber). The third set of image frames 1320 may include the reference image frame 324 (e.g., the same reference image frame may be used until reset), a third image frame 1322, and a third denoised image frame 1324. FIG. 13D depicts a fourth set of image frames 1330 at a fourth-time step of a counting operation that is subsequent to the third time (e.g., as the object continues to fall through a counting chamber). The fourth set of image frames 1330 may include the reference image frame 324 (e.g., the same reference image frame may be used until reset), a fourth image frame 1332, and a third denoised image frame 1334.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method, the computer-implemented method comprising generating, by one or more processors, an object-specific denoised image frame for an image frame based on a contrast threshold corresponding to one or more shared object attributes for a target object; generating, by the one or more processors and using an object detection model, an object matrix indicative of one or more target object candidates based on the object-specific denoised image frame; generating, by the one or more processors, a plurality of object-specific attributes for the one or more target object candidates based on the object matrix; tracking, by the one or more processors, the target object from the one or more target object candidates based on the plurality of object-specific attributes; and in response to tracking the target object, recording, by the one or more processors, a recorded target object corresponding to the target object based on the plurality of object-specific attributes; and modifying, by the one or more processors, an object-specific count for the recorded target object.

Example 2. The computer-implemented method of example 1 further comprising modifying a total object count in response to the object-specific count satisfying a threshold detection count.

Example 3. The computer-implemented method of any of the preceding examples, wherein the object matrix is indicative of a plurality of points of interest for each of the one or more target object candidates and the plurality of object-specific attributes is based on the plurality of points of interest.

Example 4. The computer-implemented method of example 3, wherein the object detection model comprises a corner detection model and the plurality of points of interest are based on a plurality of corner points for the target object.

Example 5. The computer-implemented method of example 4, wherein the plurality of object-specific attributes is indicative of (i) a number of the plurality of points of interest for the target object and (ii) an object size of the target object based on the plurality of points of interest, and wherein the computer-implemented method further comprises identifying the target object based on (i) a first comparison between the object size and a target object size threshold and (ii) a second comparison between the number of the plurality of points of interest and a target object corner threshold.

Example 6. The computer-implemented method of example 5, wherein the target object size threshold is based on the one or more shared object attributes.

Example 7. The computer-implemented method of example 6, wherein the one or more shared object attributes are indicative of a minimum size for a plurality of calibration target objects and the target object size threshold is a percentage of the minimum size.

Example 8. The computer-implemented method of any of the preceding examples, wherein the recorded target object is stored within a temporary object lookup structure and comprises a plurality of recorded object attributes indicative of a recorded object size, a recorded object vertical position, and the object-specific count.

Example 9. The computer-implemented method of example 8, wherein the plurality of object-specific attributes is indicative of a vertical position and an object size of the target object, and wherein the target object is tracked based on at least one or more of (i) a first comparison between the recorded object size and the object size of the target object, (ii) a second comparison between the recorded object vertical position and the vertical position of the target object, or (iii) a third comparison based on the distance between a recorded object center point and a center point of the target object.

Example 10. The computer-implemented method of example 9, wherein the plurality of recorded object attributes is indicative of an image frame length that is indicative of a number of image frames processed subsequent to a generation of the recorded target object, and wherein the computer-implemented method further comprises modifying the temporary object lookup structure to remove the recorded target object in response to the image frame length satisfying a frame holdover threshold.

Example 11. The computer-implemented method of any of the preceding examples, wherein the plurality of object-specific attributes is indicative of a center position of the target object, the center position comprises one or more image coordinates corresponding to a center point of the target object that are indicative of a vertical position and a horizontal position of the target object.

Example 12. The computer-implemented method of any of the preceding examples, wherein the one or more shared object attributes are indicative of an object consistency, an object color, and an object opacity.

Example 13. The computer-implemented method of any of the preceding examples further comprising adjusting the contrast threshold based on a modification to the one or more shared object attributes.

Example 14. A computing system comprising memory and one or more processors communicatively coupled to the memory, the one or more processors configured to generate an object-specific denoised image frame for an image frame based on a contrast threshold corresponding to one or more shared object attributes for a target object; generate, using an object detection model, an object matrix indicative of one or more target object candidates based on the object-specific denoised image frame; generate a plurality of object-specific attributes for the one or more target object candidates based on the object matrix; track the target object from the one or more target object candidates based on the plurality of object-specific attributes; and in response to tracking the target object, recording a recorded target object corresponding to the target object based on the plurality of object-specific attributes; and modify an object-specific count for the recorded target object.

Example 15. The computing system of example 14, wherein the one or more processors are further configured to modify a total object count in response to the object-specific count satisfying a threshold detection count.

Example 16. The computing system of examples 14 or 15, wherein the object matrix is indicative of a plurality of points of interest for each of the one or more target object candidates and the plurality of object-specific attributes is based on the plurality of points of interest.

Example 17. The computing system of example 16, wherein the object detection model comprises a corner detection model and the plurality of points of interest are based on a plurality of corner points for the target object.

Example 18. The computing system of example 17, wherein the plurality of object-specific attributes is indicative of (i) a number of the plurality of points of interest for the target object and (ii) an object size of the target object based on the plurality of points of interest, and wherein the one or more processors are further configured to identify the target object based on (i) a first comparison between the object size and a target object size threshold and (ii) a second comparison between the number of the plurality of points of interest and a target object corner threshold.

Example 19. One or more non-transitory computer-readable storage media including instructions that, when executed by one or more processors, cause the one or more processors to generate an object-specific denoised image frame for an image frame based on a contrast threshold corresponding to one or more shared object attributes for a target object; generate, using an object detection model, an object matrix indicative of one or more target object candidates based on the object-specific denoised image frame; generate a plurality of object-specific attributes for the one or more target object candidates based on the object matrix; track the target object from the one or more target object candidates based on the plurality of object-specific attributes; and in response to tracking the target object, record a recorded target object corresponding to the target object based on the plurality of object-specific attributes; and modify an object-specific count for the recorded target object.

Example 20. The one or more non-transitory computer-readable storage media of example 19, wherein the recorded target object is stored within a temporary object lookup structure and comprises a plurality of recorded object attributes indicative of a recorded object size, a recorded object vertical position, and the object-specific count.

What is claimed is:

1. A computer-implemented method, the computer-implemented method comprising:
generating, by one or more processors, an object-specific denoised image frame for an image frame based on a contrast threshold corresponding to one or more shared object attributes for a tracked target object;
generating, by the one or more processors and using an object detection model, an object matrix indicative of one or more target object candidates based on the object-specific denoised image frame;
generating, by the one or more processors, a plurality of object-specific attributes for the one or more target object candidates based on the object matrix;
tracking, by the one or more processors, the tracked target object from the one or more target object candidates based on the plurality of object-specific attributes; and
in response to tracking the tracked target object,
recording, by the one or more processors, a recorded target object corresponding to the tracked target object based on the plurality of object-specific attributes; and
modifying, by the one or more processors, an object-specific count for the recorded target object.

2. The computer-implemented method of claim 1 further comprising:
modifying a total object count in response to the object-specific count satisfying a threshold detection count.

3. The computer-implemented method of claim 1, wherein the object matrix is indicative of a plurality of points of interest for each of the one or more target object candidates and the plurality of object-specific attributes is based on the plurality of points of interest.

4. The computer-implemented method of claim 3, wherein the object detection model comprises a corner detection model and the plurality of points of interest are based on a plurality of corner points for the tracked target object.

5. The computer-implemented method of claim 4, wherein the plurality of object-specific attributes is indicative of (i) a number of the plurality of points of interest for the tracked target object and (ii) an object size of the tracked target object based on the plurality of points of interest, and wherein the computer-implemented method further comprises:
identifying the tracked target object based on (i) a first comparison between the object size and a target object size threshold and (ii) a second comparison between the number of the plurality of points of interest and a target object corner threshold.

6. The computer-implemented method of claim 5, wherein the target object size threshold is based on the one or more shared object attributes.

7. The computer-implemented method of claim 6, wherein the one or more shared object attributes are indicative of a minimum size for a plurality of calibration target objects and the target object size threshold is a percentage of the minimum size.

8. The computer-implemented method of claim 1, wherein the recorded target object is stored within a temporary object lookup structure and comprises a plurality of recorded object attributes indicative of a recorded object size, a recorded object vertical position, and the object-specific count.

9. The computer-implemented method of claim 8, wherein the plurality of object-specific attributes is indicative of a vertical position and an object size of the tracked target object, and wherein the tracked target object is tracked based on at least one or more of (i) a first comparison between the recorded object size and the object size of the tracked target object, (ii) a second comparison between the recorded object vertical position and the vertical position of the tracked target object, or (iii) a third comparison based on a distance between a recorded object center point and a center point of the tracked target object.

10. The computer-implemented method of claim 9, wherein the plurality of recorded object attributes is indicative of an image frame length that is indicative of a number of image frames processed subsequent to a generation of the recorded target object, and wherein the computer-implemented method further comprises:
modifying the temporary object lookup structure to remove the recorded target object in response to the image frame length satisfying a frame holdover threshold.

11. The computer-implemented method of claim 1, wherein the plurality of object-specific attributes is indicative of a center position of the tracked target object, the center position comprises one or more image coordinates corresponding to a center point of the tracked target object that are indicative of a vertical position and a horizontal position of the tracked target object.

12. The computer-implemented method of claim 1, wherein the one or more shared object attributes are indicative of an object consistency, an object color, and an object opacity.

13. The computer-implemented method of claim 1 further comprising:
adjusting the contrast threshold based on a modification to the one or more shared object attributes.

14. A computing system comprising memory and one or more processors communicatively coupled to the memory, the one or more processors configured to:
generate an object-specific denoised image frame for an image frame based on a contrast threshold corresponding to one or more shared object attributes for a tracked target object;
generate, using an object detection model, an object matrix indicative of one or more target object candidates based on the object-specific denoised image frame;
generate a plurality of object-specific attributes for the one or more target object candidates based on the object matrix;
track the tracked target object from the one or more target object candidates based on the plurality of object-specific attributes; and
in response to tracking the tracked target object, record a recorded target object corresponding to the tracked target object based on the plurality of object-specific attributes; and
modify an object-specific count for the recorded target object.

15. The computing system of claim 14, wherein the one or more processors are further configured to:
modify a total object count in response to the object-specific count satisfying a threshold detection count.

16. The computing system of claim 14, wherein the object matrix is indicative of a plurality of points of interest for each of the one or more target object candidates and the plurality of object-specific attributes is based on the plurality of points of interest.

17. The computing system of claim 16, wherein the object detection model comprises a corner detection model and the plurality of points of interest are based on a plurality of corner points for the tracked target object.

18. The computing system of claim 17, wherein the plurality of object-specific attributes is indicative of (i) a number of the plurality of points of interest for the tracked target object and (ii) an object size of the tracked target object based on the plurality of points of interest, and wherein the one or more processors are further configured to:
identify the target object based on (i) a first comparison between the object size and a target object size threshold and (ii) a second comparison between the number of the plurality of points of interest and a target object corner threshold.

19. One or more non-transitory computer-readable storage media including instructions that, when executed by one or more processors, cause the one or more processors to:
generate an object-specific denoised image frame for an image frame based on a contrast threshold corresponding to one or more shared object attributes for a tracked target object;
generate, using an object detection model, an object matrix indicative of one or more target object candidates based on the object-specific denoised image frame;
generate a plurality of object-specific attributes for the one or more target object candidates based on the object matrix;
track the tracked target object from the one or more target object candidates based on the plurality of object-specific attributes; and
in response to tracking the tracked target object,
record a tracked target object corresponding to the tracked target object based on the plurality of object-specific attributes; and
modify an object-specific count for the recorded target object.

20. The one or more non-transitory computer-readable storage media of claim 19, wherein the recorded target object is stored within a temporary object lookup structure and comprises a plurality of recorded object attributes indicative of a recorded object size, a recorded object vertical position, and the object-specific count.
